(19) United States
(12) Patent Application Publication
(10) Pub. No.: US 2024/0231251 A1
(43) Pub. Date: Jul. 11, 2024

(54) TONER

(71) Applicant: CANON KABUSHIKI KAISHA, Tokyo (JP)

(72) Inventors: NAOYA ISONO, Shizuoka (JP); MARIKO YAMASHITA, Shizuoka (JP); KENJI AOKI, Shizuoka (JP); TATSUYA SAEKI, Shizuoka (JP); YUKI MASUDA, Shizuoka (JP); MEGUMI MORIYA, Shizuoka (JP)

(21) Appl. No.: 18/392,903

(22) Filed: Dec. 21, 2023

(30) Foreign Application Priority Data
Dec. 21, 2022 (JP) 2022-204138

(51) Int. Cl. G03G 9/097; G03G 9/087; G03G 9/09

(52) U.S. Cl. CPC G03G 9/09775; G03G 9/08711; G03G 9/0904; G03G 9/091; G03G 9/092; G03G 9/09733

(57) ABSTRACT

Provided is such a toner that a pigment is dispersed in a toner particle containing a large amount of a crystalline resin, that is, a toner excellent in low-temperature fixability and coloring power. The toner is a toner including a toner particle containing a binder resin, a pigment and a pigment dispersant, wherein the binder resin contains from 20.0% to 100.0% by mass of a crystalline resin, wherein the pigment dispersant is a polymer containing a specific structure that interacts with the pigment and a specific polymer moiety that interacts with the crystalline resin.

### BACKGROUND

### Field of the Disclosure

The present disclosure relates to a toner to be used for developing an electrostatic latent image formed by a method, such as an electrophotographic method, an electrostatic recording method or a toner jet system recording method, to form a toner image.

### Description of the Related Art

Energy savings in an electrophotographic apparatus have hitherto been considered to be a large technical problem and hence a significant reduction in quantity of heat to be applied to a fixing device has been investigated. In particular, in a toner, there has been a growing need for so-called “low-temperature fixability” by which the toner can be fixed with lower energy.

A method including using a crystalline resin as a binder resin has been investigated as an approach to enabling fixation at low temperatures. The molecular chains of the crystalline resin are regularly arrayed and hence the resin has such a property as to be substantially free from softening at temperatures lower than its melting point. In addition, when the temperature of the crystalline resin exceeds the melting point, its crystal abruptly melts and an abrupt reduction in viscosity thereof along with the melting occurs. Accordingly, the resin has been attracting attention as a material that is excellent in sharp melt property and shows low-temperature fixability.

In Japanese Patent Application Laid-Open No. 2014-142632, there is a proposal of a toner characterized in that in the observation of a section of a toner particle, a sea-island structure, which includes a sea portion containing a crystalline resin as a main component and an island portion containing an amorphous resin as a main component, is observed. The toner described in Japanese Patent Application Laid-Open No. 2014-142632 enables fixation at low energy. However, the crystal portion is liable to adversely affect the dispersion of a colorant such as a pigment to reduce its coloring power.

Meanwhile, in Japanese Patent Application Laid-Open No. 2016-157104, there is a proposal of the following toner: in a toner particle containing a binder resin, a crystalline polyester and a pigment dispersant, a relationship between the hydrophobicity parameters of the crystalline polyester and the pigment dispersant is specified. The toner described in Japanese Patent Application Laid-Open No. 2016-157104 achieves both of low-temperature fixability and coloring power.

However, in such a system that a large amount of a crystalline resin has been introduced into a binder resin for further energy savings, even when the pigment dispersant disclosed in Japanese Patent Application Laid-Open No. 2016-157104 is used, its effect is limited and hence the coloring power of a toner cannot be improved. Accordingly, improvements in low-temperature fixability and coloring power of the toner have still been required.

### SUMMARY

The present disclosure provides such a toner that a pigment is dispersed in a toner particle containing a large amount of a crystalline resin, that is, a toner excellent in low-temperature fixability and coloring power.

The present disclosure relates to a toner comprising a toner particle comprising a binder resin, a pigment and a pigment dispersant, wherein the binder resin contains from 20.0% to 100.0% by mass of a crystalline resin, wherein the pigment dispersant comprises: a structure represented by the following formula (1); and a polymer moiety comprising a monomer unit represented by the following formula (3), wherein a content of the structure represented by the following formula (1) in the pigment dispersant is from 1.0% to 15.0% by mass s, wherein a content of the monomer unit represented by the following formula (3) in the pigment dispersant is from 45.0% to 80.0% by mass, and wherein the pigment dispersant has a weight-average molecular weight (Mw) from 10,000 to 50,000:

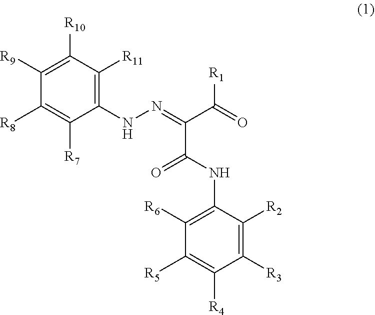

in the formula (1), R₁ represents an alkyl group having a substituent, an alkyl group free of a substituent, a phenyl group having a substituent or a phenyl group free of a substituent, at least one of R₂, R₃, R₄, R₅, R₆, R₇, R₈, R₉, R₁₀ or R₁₁ represents a linking group to the polymer moiety or a moiety that is bonded to the polymer moiety with a single bond, and R₂ to R₁₁ except the linking group each independently represent a hydrogen atom, a halogen atom, an alkyl group, an alkoxy group, a hydroxy group, an amino group, a cyano group, a trifluoromethyl group, a carboxy group or a group represented by the following formula (2-1) or adjacent groups out of R₂ to R₁₁ form a group represented by the following formula (2-2):

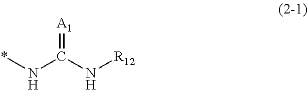

in the formula (2-1), * represents a bonding site to an aromatic ring having R₂ to R₆ or R₇ to R₁₁ in the formula (1), R₁₂ represents a hydrogen atom, a substituted or unsubstituted alkyl group, an aralkyl group, a substituted or unsubstituted alkyloxycarbonyl group or a substituted or unsubstituted aralkyloxycarbonyl group, A₁ represents an oxygen atom, a sulfur atom or an NR₁₃ group, and R₁₃ represents a hydrogen atom, a substituted or unsubstituted alkyloxycarbonyl group or a substituted or unsubstituted aralkyloxycarbonyl group;

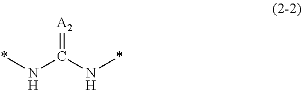

in the formula (2-2), * represents a bonding site to an aromatic ring having R₂ to R₆ or R₇ to R₁₁ in the formula (1), the group represented by the formula (2-2) forms a 5-membered heterocycle by being bonded to the aromatic ring having R₂ to R₆ or R₇ to R₁₁ in the formula (1), A₂ represents an oxygen atom, a sulfur atom or an NR₁₃ group, and R₁₃ represents a hydrogen atom, a substituted or unsubstituted alkyloxycarbonyl group or a substituted or unsubstituted aralkyloxycarbonyl group; and

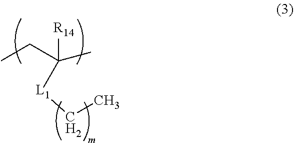

in the formula (3), R₁₄ represents a hydrogen atom or a methyl group, L₁ represents an ester bond or an amide bond, and “m” represents an integer from 20 to 30.

Further features of the present disclosure will become apparent from the following description of exemplary embodiments.

### DESCRIPTION OF THE EMBODIMENTS

The description “XX or more and YY or less” or “from XX to YY” representing a numerical range means a numerical range including a lower limit and an upper limit that are end points unless otherwise stated.

### Features of the Present Disclosure

The present disclosure relates to a toner including a toner particle containing a binder resin, a pigment and a pigment dispersant,
(i) wherein the binder resin contains from 20.0% to 100.0% by mass of a crystalline resin,
(ii) wherein the pigment dispersant includes: a structure represented by the following formula (1); and a polymer moiety containing a monomer unit represented by the following formula (3), wherein a content of the structure represented by the following formula (1) in the pigment dispersant is from 1.0% to 15.0% by mass, (ii) wherein a content of the monomer unit represented by the following formula (3) in the pigment dispersant is from 45.0% to 80.0% by mass, and
(iii) wherein the pigment dispersant has a weight-average molecular weight (Mw) from 10,000 to 50,000:

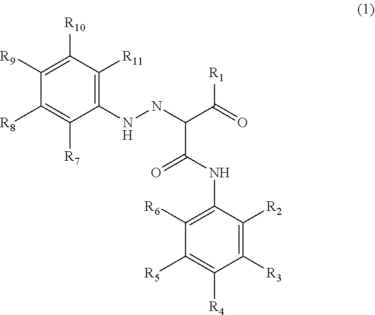

in the formula (1), R₁ represents an alkyl group having a substituent, an alkyl group free of a substituent, a phenyl group having a substituent or a phenyl group free of a substituent, at least one of R₂, R₃, R₄, R₅, R₆, R₇, R₈, R₉, R₁₀ or R₁₁ represents a linking group to the polymer moiety or a moiety that is bonded to the polymer moiety with a single bond, and R₂ to R₁₁ except the linking group each independently represent a hydrogen atom, a halogen atom, an alkyl group, an alkoxy group, a hydroxy group, an amino group, a cyano group, a trifluoromethyl group, a carboxy group or a group represented by the following formula (2-1) or adjacent groups out of R₂ to R₁₁ form a group represented by the following formula (2-2):

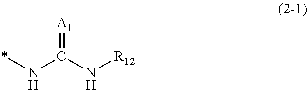

in the formula (2-1), * represents a bonding site to an aromatic ring having R₂ to R₆ or R₇ to R₁₁ in the formula (1), R₁₂ represents a hydrogen atom, a substituted or unsubstituted alkyl group, an aralkyl group, a substituted or unsubstituted alkyloxycarbonyl group or a substituted or unsubstituted aralkyloxycarbonyl group, A₁ represents an oxygen atom, a sulfur atom or an NR₁₃ group, and R₁₃ represents a hydrogen atom, a substituted or unsubstituted alkyloxycarbonyl group or a substituted or unsubstituted aralkyloxycarbonyl group;

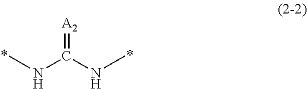

in the formula (2-2), * represents a bonding site to an aromatic ring having R₂ to R₆ or R₇ to R₁₁ in the formula (1), the group represented by the formula (2-2) forms a 5-membered heterocycle by being bonded to the aromatic ring having R₂ to R₆ or R₇ to R₁₁ in the formula (1), A₂ represents an oxygen atom, a sulfur atom or an NR₁₃ group, and R₁₃ represents a hydrogen atom, a substituted or unsubstituted alkyloxycarbonyl group or a substituted or unsubstituted aralkyloxycarbonyl group; and

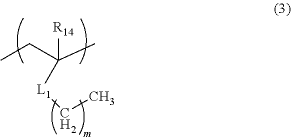

in the formula (3), R₁₄ represents a hydrogen atom or a methyl group, L₁ represents an ester bond or an amide bond, and “m” represents an integer from 20 to 30.

The above-mentioned respective requirements are described in detail below.

The toner of the present disclosure is a toner including the toner particle containing the binder resin, which contains from 20.0% to 100.0% by mass of the crystalline resin, the pigment and the pigment dispersant.

The pigment dispersant has a polymer containing a structure represented by the formula (1) and a polymer moiety containing monomer unit represented by the formula (3).

In addition, the content of the structure represented by the formula (1) in the pigment dispersant is from 1.0% to 15.0% by mass and the content of the monomer unit represented by the formula (3) therein is from 45.0% to 80.0% by mass.

Further, the pigment dispersant has a weight-average molecular weight (Mw) from 10,000 to 50,000. The requirements are as described above.

The inventors of the present disclosure have found that the satisfaction of the above-mentioned conditions provides a toner excellent in low-temperature fixability and coloring power. The inventors of the present disclosure have conceived a mechanism therefor to be as described below.

When the pigment is dispersed in the binder resin containing 20.0% by mass or more of the crystalline resin, design taking an interaction between the binder resin and the pigment dispersant into consideration is required. Specifically, there is a need to use a pigment dispersant having: a “moiety that interacts with the pigment,” the moiety being represented by the formula (1); and a “moiety that interacts with the crystalline resin,” the moiety containing the monomer unit represented by the formula (3).

In addition, it is required that the content of the structure represented by the formula (1) in the pigment dispersant is from 1.0% to 15.0% by mass and the content of the monomer unit represented by the formula (3) therein is from 45.0% to 80.0% by mass. The setting of the contents within the ranges can strike a balance between: the interaction between the pigment and the pigment dispersant; and the interaction between the pigment dispersant and the crystalline resin.

Herein, the structure represented by the formula (1) easily interacts with a functional group of the pigment because the structure expresses strong π-π interactivity and has a strong hydrogen bonding property. The incorporation of a regulated amount of the structure represented by the formula (1) enables the intervention of the pigment dispersant near the pigment. Meanwhile, the incorporation of a regulated amount of the monomer unit represented by the formula (3) improves the affinity of the pigment dispersant for the crystalline resin. Accordingly, even in the binder resin containing 20.0% by mass or more of the crystalline resin, the polymer chain of a polymer moiety derived from the monomer unit represented by the formula (3) can spread in the binder resin. In addition, the spread polymer chain expresses steric hindrance to suppress the aggregation of the molecules of the pigment. Thus, a toner excellent in low-temperature fixability and coloring power, which is an effect of this case, is obtained.

When the content of the structure represented by the formula (1) is less than 1.0% by mass, the effect of the present disclosure is not obtained because the amount of the structure that interacts with the pigment is small and hence the pigment dispersant cannot intervene near the pigment. When the content is more than 15.0% by mass, the ratio of the structure represented by the formula (1) in the pigment dispersant becomes so large that the polymer chain (also referred to as “loop length”) of a polymer moiety between one of the structure represented by the formula (1) and another one of the structure represented by the formula (1) is not sufficient. Accordingly, steric hindrance for suppressing the aggregation of the molecules of the pigment is not obtained. Thus, the coloring power of the toner reduces.

When the content of the monomer unit represented by the formula (3) is less than 45.0% by mass, in the binder resin containing 20% or more of the crystalline resin, the affinity of the pigment dispersant for the binder resin is low and hence the polymer moiety shrinks. Accordingly, steric hindrance for suppressing the aggregation of the molecules of the pigment is not obtained. Thus, the coloring power reduces. In addition, the melting point of the pigment dispersant reduces and hence the heat-resistant storage stability of the toner deteriorates. When the content of the monomer unit represented by the formula (3) is more than 80.0% by mass, the affinity of the pigment dispersant for the crystalline resin becomes so high that the pigment dispersant is taken in the binder resin and hence cannot intervene around the pigment. Thus, the coloring power reduces.

When the weight-average molecular weight (Mw) of the pigment dispersant is less than 10,000, no steric hindrance is obtained and hence the aggregation of the molecules of the pigment cannot be suppressed. Thus, the coloring power reduces. In addition, crystallinity derived from a side-chain portion of the polymer moiety is not obtained. Accordingly, when the toner is produced, the pigment dispersant serves as a low-melting point component to deteriorate the heat resistance and storage stability of the toner. When the weight-average molecular weight is more than 50,000, an intermolecular interaction between the side-chain portion of the polymer moiety and the crystalline resin in the binder resin enlarges. As a result, the interaction becomes larger than the above-mentioned interaction between the structure represented by the formula (1) and the pigment. Accordingly, the pigment dispersant is released from the pigment and is hence taken in the crystalline resin in the binder resin. Thus, the effect of the present disclosure is not obtained and hence the coloring power reduces. In order that the pigment dispersant of the present disclosure may exhibit its effect in the binder resin containing a large amount of the crystalline resin, a balance between the content of the structure represented by the formula (1) or the formula (3) in the pigment dispersant and the molecular weight thereof is important.

### [Configurations of Toner]

### <With Regard to Structure Represented by Formula (1) of Pigment Dispersant>

The details of the structure represented by the formula (1) in the pigment dispersant are described.

Examples of the alkyl group represented by R₁ in the formula (1) include linear, branched and cyclic alkyl groups, such as a methyl group, an ethyl group, a n-propyl group, a n-butyl group, a n-pentyl group, a n-hexyl group, an isopropyl group, an isobutyl group, a sec-butyl group, a tert-butyl group and a cyclohexyl group.

The alkyl group or phenyl group represented by R₁ in the formula (1) may be further substituted with a substituent as long as an affinity for a pigment is not significantly inhibited. In this case, examples of the substituent with which the group may be substituted include a halogen atom, a nitro group, an amino group, a hydroxy group, a cyano group and a trifluoromethyl group.

From the viewpoint of an affinity for a pigment, R₁ in the formula (1) preferably represents a methyl group out of the above-mentioned groups.

With regard to R₂ to R₆ in the formula (1), at least one of R₂ to R₆ preferably represents a linking group that forms a bonding portion to a polymer moiety from the viewpoint of an affinity for the pigment.

R₂ to R₆ except the linking group each independently represent a hydrogen atom, a halogen atom, an alkyl group, an alkoxy group, a hydroxy group, a cyano group, a trifluoromethyl group, a carboxy group, a group represented by the formula (2-1) or a group represented by the formula (2-2).

R₂ to R₆ except the linking group each more preferably represent a hydrogen atom.

R₇ to R₁₁ in the formula (1) each independently represent a hydrogen atom, a halogen atom, an alkyl group, an alkoxy group, a hydroxy group, a cyano group, a trifluoromethyl group, a carboxy group, a group represented by the formula (2-1) or a group represented by the formula (2-2).

In particular, at least one of R₇ to R₁₁ preferably represents the group represented by the formula (2-1) or the formula (2-2) from the viewpoint of an affinity for the pigment. Further, R₇ to R₁₁ except the group represented by the formula (2-1) or the formula (2-2) each preferably represent a hydrogen atom. An example of a structure that satisfies this aspect is shown in the following formula (4):

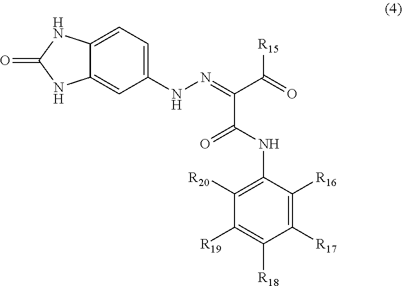

in the formula (4), R₁₅ represents a substituted or unsubstituted alkyl group or a substituted or unsubstituted phenyl group, at least one of R₁₆ to R₂₀ represents a linking group that forms a bonding portion to the polymer moiety and R₁₆ to R₂₀ except the linking group each independently represent a hydrogen atom, a halogen atom, an alkyl group, an alkoxy group, a hydroxy group, an amino group, a cyano group, a trifluoromethyl group or a carboxy group.

Examples of the alkyl group represented by R₁₂ in the formula (2-1) include linear, branched and cyclic alkyl groups, such as a methyl group, an ethyl group, a n-propyl group, a n-butyl group, a n-pentyl group, a n-hexyl group, an isopropyl group, an isobutyl group, a sec-butyl group, a tert-butyl group and a cyclohexyl group.

Examples of the aralkyl group represented by R₁₂ in the formula (2-1) include a benzyl group and a phenethyl group.

Examples of the alkyloxycarbonyl group (—C(═O)—O-Alkyl) represented by R₁₂ in the formula (2-1) include a methoxycarbonyl group, an ethoxycarbonyl group, a n-propoxycarbonyl group, an isopropoxycarbonyl group, a n-butoxycarbonyl group, an isobutoxycarbonyl group, a sec-butoxycarbonyl group, a tert-butoxycarbonyl group, a n-pentyloxycarbonyl group and a n-hexyloxycarbonyl group.

Examples of the aralkyloxycarbonyl group (—C(═O)—O-Aralkyl) represented by R₁₂ in the formula (2-1) include a benzyloxycarbonyl group and a phenethyloxycarbonyl group.

From the viewpoint of an affinity for the pigment, R₁₂ preferably represents a hydrogen atom, a methyl group or an ethyl group out of the above-mentioned groups.

A₁ in the formula (2-1) and A₂ in the formula (2-2) may each be appropriately selected from an oxygen atom, a sulfur atom and an NR₁₃ group. R₁₃ preferably represents a hydrogen atom, a tert-butoxycarbonyl group or a benzyloxycarbonyl group. A₁ and A₂ each more preferably represent an oxygen atom out of the above-mentioned atom and groups, from the viewpoint of an affinity for the pigment.

The linking group for linking the structure represented by the formula (1) and the polymer moiety is not particularly limited as long as the linking group is a divalent linking group. Examples thereof include an ester bond (—COO—), a thioester bond (—COS—) and a carboxylic acid amide bond (—CONH—). Of those, an ester bond or a carboxylic acid amide bond is preferred.

Specifically, the linking group is particularly preferably a linking group represented by the following formula (L1) or (L2):

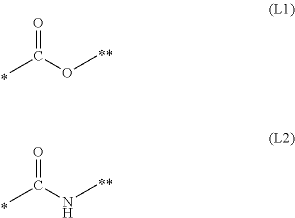

in each of the formulae (L1) and (L2), * represents a bonding site to a carbon atom in the polymer moiety and ** represents a bonding site to a carbon atom of an aromatic ring in the structure represented by the formula (1).

When the polymer moiety and the structure represented by the formula (1) or the formula (4) are bonded to each other via a functional group such as an carboxylic acid ester bond (—COO—) derived from the polymer moiety, the bonding portion including such functional group is referred to as “linking group.”

### <With Regard to Polymer Moiety of Pigment Dispersant>

Next, details about the polymer moiety are described.

It is essential for the polymer moiety to contain the monomer unit represented by the formula (3) in a predetermined amount and a specific monomer for forming the monomer unit represented by the formula (3) is, for example, behenyl acrylate, behenyl methacrylate, acrylic acid octacosane, methacrylic acid octacosane, acrylic acid triacontane or methacrylic acid triacontane. Of those, behenyl acrylate or behenyl methacrylate is preferred.

The polymer moiety preferably contains a component derived from any one of the following monomers in addition to a predetermined amount of the monomer unit represented by the formula (3) described above.

Examples of the monomer include: styrene and styrene derivatives, such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene and p-phenylstyrene; acrylic polymerizable monomers, such as acrylic acid, methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, n-lauryl acrylate, cyclohexyl acrylate, 2-methoxyethyl acrylate, benzyl acrylate, dimethylphosphate ethyl acrylate, diethylphosphate ethyl acrylate, dibutylphosphate ethyl acrylate and 2-benzoyloxyethyl acrylate; methacrylic polymerizable monomers, such as methacrylic acid, methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, 2-methoxyethyl methacrylate, diethylphosphate ethyl methacrylate and dibutylphosphate ethyl methacrylate; and acrylonitrile and methacrylonitrile.

The polymer moiety may be produced by using any one of the following polymerization methods: solution polymerization, suspension polymerization, emulsion polymerization, dispersion polymerization, precipitation polymerization and bulk polymerization. Of those, solution polymerization in a solvent that can dissolve the respective components to be used at the time of the production is preferred, though a method for the production is not particularly limited. Specific examples of the solvent include: polar organic solvents including alcohols, such as methanol, ethanol and 2-propanol, ketones, such as acetone and methyl ethyl ketone, ethers, such as tetrahydrofuran and diethyl ether, ethylene glycol monoalkyl ethers or acetates thereof, propylene glycol monoalkyl ethers or acetates thereof and diethylene glycol monoalkyl ethers; and non-polar solvents including toluene and xylene. Those solvents may be used alone or as a mixture thereof.

In the polymer moiety, as shown in the following formula, X corresponding to the monomer unit represented by the formula (3), Z that is linked to the formula (1) and, as required, Y corresponding to another monomer unit are randomly arranged.

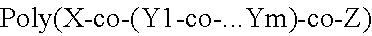

In the structural formula, X represents the monomer unit represented by the formula (3), Z represents a monomer unit that is linked to the formula (1), Y1 to Ym each represent another monomer unit and “co” is a symbol representing the random arrangement of monomer units for forming a copolymer.

The pigment dispersant preferably has a melting point peak derived from the polymer moiety from 50° C. to 70° C. in DSC measurement. When the pigment dispersant has a melting point peak from 50° C. to 70° C., the pigment dispersant is excellent in thermal deformability and has satisfactory storage stability. The melting point peak may be adjusted by the content of the monomer unit represented by the formula (3) and the kind and content of any other monomer.

### <Crystalline Resin>

Examples of the crystalline resin include a vinyl resin, a polyester resin, a polyurethane resin and an epoxy resin each having crystallinity. Of those, a vinyl resin or a polyester resin having crystallinity is preferred. A vinyl resin having crystallinity is more preferred.

In the case of the vinyl resin having crystallinity, a unit represented by the formula (4) is preferably incorporated thereinto:

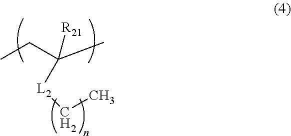

in the formula (5), R₂₁ represents a hydrogen atom or a methyl group, L₂ represents a single bond, an ester bond or an amide bond, and “n” represents an integer from 15 to 30.

The presence of the unit represented by the formula (5) facilitates the formation of a side-chain crystal structure. Accordingly, the toner obtains a sharp melt property and is more easily improved in low-temperature fixability. “n” in the formula (5) represents preferably from 17 to 29, more preferably from 19 to 23.

The vinyl resin may have any other unit in addition to the unit represented by the formula (5). A method including copolymerizing the unit represented by the formula (5) and any other polymerizable monomer is available as a method for the introduction of the other unit.

Examples of the other polymerizable monomer include the following monomers.

Examples of the monomer include: styrene and styrene derivatives, such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene and p-phenylstyrene; acrylic polymerizable monomers, such as acrylic acid, methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, n-lauryl acrylate, cyclohexyl acrylate, 2-methoxyethyl acrylate, benzyl acrylate, dimethylphosphate ethyl acrylate, diethylphosphate ethyl acrylate, dibutylphosphate ethyl acrylate, 2-benzoyloxyethyl acrylate and acrylonitrile; and methacrylic polymerizable monomers, such as methacrylic acid, methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, 2-methoxyethyl methacrylate, diethylphosphate ethyl methacrylate, dibutylphosphate ethyl methacrylate and methacrylonitrile.

Of those, styrene, methacrylic acid, acrylic acid, acrylonitrile or methacrylonitrile is preferably used.

A polarity parameter P1 of the pigment dispersant and a polarity parameter P2 of the crystalline resin preferably satisfy the following formula:

$$\vert P 1 - P 2 \vert \leq 0.1$$

where P1 represents a volume fraction of acetonitrile at a precipitation point of the pigment dispersant determined by adding 0.10 part by mass of acetonitrile to a solution formed of 0.05 part by mass of the pigment dispersant and 1.48 parts by mass of chloroform, and P2 represents a volume fraction of acetonitrile at a precipitation point of the crystalline resin when 0.10 part by mass of acetonitrile is added to a solution formed of 0.05 part by mass of the crystalline resin and 1.48 parts by mass of chloroform.

The values of the polarity parameters of the pigment dispersant and the crystalline resin are preferably as close as possible to each other because the affinity therebetween is improved. The P1 may be controlled by changing the composition of the polymer moiety of the pigment dispersant. The P2 may be controlled by changing the composition of the crystalline resin. Details about a method of measuring the polarity parameters are described later.

### <Other Binder Resin>

The binder resin preferably contains an amorphous resin. It is preferred that when a section of the toner particle is observed with a scanning transmission electron microscope, the section have a matrix-domain structure, the crystalline resin be incorporated as a main component into a matrix and the amorphous resin be incorporated as a main component into a domain. In this case, the toner is excellent in durability and hot offset resistance. Examples of the amorphous resin include a vinyl resin, a polyester resin, a polyurethane resin and an epoxy resin. Of those, a vinyl resin is preferred.

Although the incorporation of the crystalline resin as the main component in the matrix as described above makes the above-mentioned characteristics excellent, the crystalline resin in the matrix is liable to affect the dispersion of the pigment to cause a reduction in coloring power of the toner. However, the use of the pigment dispersant of the present disclosure enables the dispersion of the pigment without any influence of the crystalline resin in the matrix and hence provides high coloring power.

### <Pigment>

The pigment preferably contains a pigment selected from the following group: carbon black; C.I. Pigment Yellows 74, 93, 139, 155, 180 and 185; C.I. Pigment Reds 31, 122, 150, 170, 185, 258 and 269; and C.I. Pigment Blues 15:3 and 15:4.

In the case of the pigment selected from the above-mentioned group, the adsorption of the pigment dispersant to the pigment caused by a π-π interaction or a hydrogen bonding action acts more strongly. Accordingly, the pigment dispersant easily intervenes near the pigment and hence easily improves the dispersibility of the pigment.

Of those, carbon black, C.I. Pigment Yellows 155, 180 and 185, C.I. Pigment Reds 122 and 150 and C.I. Pigment Blue 15:3 are more preferred.

In addition, the content of the pigment dispersant with respect to the pigment is preferably from 1.0 part to 20.0 parts by mass, more preferably from 3.0 parts to 15.0 parts by mass with respect to 100 parts by mass of the pigment.

### <Wax>

A wax having a number-average molecular weight (Mn) from 300 to 3,000 is preferably used as a wax because releasability is easily secured. Although the kind of the wax is not particularly limited, a hydrocarbon-based wax or an ester wax is preferred. Examples of the hydrocarbon-based wax include the following waxes.

Aliphatic hydrocarbon-based wax: low-molecular-weight polyethylene, low-molecular-weight polypropylene, a low-molecular-weight olefin copolymer, a Fischer-Tropsch wax or a wax obtained by subjecting any one of these compounds to oxidation or acid addition.

The ester wax only needs to have at least one ester bond in a molecule thereof and any one of a natural ester wax and a synthetic ester wax may be used.

Although the ester wax is not particularly limited, examples thereof include the following waxes: esters of monohydric alcohols and monocarboxylic acids, such as behenyl behenate, stearyl stearate and palmityl palmitate; esters of divalent carboxylic acids and monoalcohols, such as dibehenyl sebacate; esters of dihydric alcohols and monocarboxylic acids, such as ethylene glycol distearate and hexanediol dibehenate; esters of trihydric alcohols and monocarboxylic acids, such as glycerin tribehenate; esters of tetrahydric alcohols and monocarboxylic acids, such as pentaerythritol tetrastearate and pentaerythritol tetrapalmitate; esters of hexahydric alcohols and monocarboxylic acids, such as dipentaerythritol hexastearate, dipentaerythritol hexapalmitate and dipentaerythritol hexabehenate; esters of polyfunctional alcohols and monocarboxylic acids, such as polyglycerin behenate; and natural ester waxes, such as carnauba wax and rice wax.

Of those, esters of hexahydric alcohols and monocarboxylic acids, such as dipentaerythritol hexastearate, dipentaerythritol hexapalmitate and dipentaerythritol hexabehenate, are preferred. The wax interacts with the pigment dispersant of the present disclosure and hence the domain size of the wax reduces. Accordingly, the uneven distribution of the pigment in the toner particle is eliminated and hence the coloring power and color gamut of the toner are further improved.

### <Method of Producing Toner Particle>

Although any production method may be used as a production method for the production of the toner particle according to the present disclosure, the toner particle is preferably obtained by a method of producing a toner particle including granulating a polymerizable monomer composition in an aqueous medium, such as a suspension polymerization method, an emulsion polymerization method or a suspension granulation method.

The method of producing the toner particle is described below by using the suspension polymerization method that is most suitable out of the methods of producing the toner particle to be used in the present disclosure.

In addition to the pigment dispersant, the pigment, the crystalline resin and the wax described above, a polymerizable monomer that produces the binder resin and any other additive to be used as required are uniformly dissolved or dispersed with a dispersing machine, such as a homogenizer, a ball mill, a colloid mill or an ultrasonic dispersing machine. A polymerization initiator is dissolved in the resultant to prepare a polymerizable monomer composition. Next, the polymerizable monomer composition is suspended in an aqueous medium containing a dispersion stabilizer and polymerized. Thus, the toner particle is produced.

Examples of a monofunctional polymerizable monomer serving as the polymerizable monomer include: styrene and styrene derivatives, such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene and p-phenylstyrene; acrylic polymerizable monomers, such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethylphosphate ethyl acrylate, diethylphosphate ethyl acrylate, dibutylphosphate ethyl acrylate and 2-benzoyloxyethyl acrylate; and methacrylic polymerizable monomers, such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethylphosphate ethyl methacrylate and dibutylphosphate ethyl methacrylate.

In addition, examples of a polyfunctional polymerizable monomer serving as the polymerizable monomer include diethylene glycol diacrylate, triethylene glycol diacrylate, tetraethylene glycol diacrylate, polyethylene glycol diacrylate, 1,6-hexanediol diacrylate, neopentyl glycol diacrylate, tripropylene glycol diacrylate, polypropylene glycol diacrylate, 2,2′-bis(4-(acryloxydiethoxy)phenyl)propane, trimethylolpropane triacrylate, tetramethylolmethane tetraacrylate, ethylene glycol dimethacrylate, diethylene glycol dimethacrylate, triethylene glycol dimethacrylate, tetraethylene glycol dimethacrylate, polyethylene glycol dimethacrylate, 1,3-butylene glycol dimethacrylate, 1,6-hexanediol dimethacrylate, neopentyl glycol dimethacrylate, polypropylene glycol dimethacrylate, 2,2′-bis(4-(methacryloxydiethoxy)phenyl)propane, 2,2′-bis(4-(methacryloxypolyethoxy)phenyl)propane, trimethylolpropane trimethacrylate, tetramethylolmethane tetramethacrylate, divinylbenzene, divinylnaphthalene and divinyl ether.

The monofunctional polymerizable monomers may be used alone or in combination thereof. The monofunctional polymerizable monomer and the polyfunctional polymerizable monomer may be used in combination. Alternatively, the polyfunctional polymerizable monomers may be used alone or in combination thereof.

The polymerization initiator may be added simultaneously with the addition of the other additive into the polymerizable monomer or may be mixed immediately before the suspension in the aqueous medium. In addition, the polymerization initiator dissolved in the polymerizable monomer or a solvent may be added immediately after the granulation and before the initiation of the polymerization reaction.

The pigment is preferably used in an amount of from 1.0 part to 20.0 parts by mass with respect to 100.0 parts by mass of the binder resin.

Examples of the polymerization initiator include an organic peroxide-based initiator and an azo-based polymerization initiator. Examples of the organic peroxide-based initiator include the following initiators: benzoyl peroxide, lauroyl peroxide, di-α-cumyl peroxide, 2,5-dimethyl-2,5-bis(benzoylperoxy)hexane, bis(4-t-butylcyclohexyl) peroxydicarbonate, 1,1-bis(t-butylperoxy)cyclododecane, t-butylperoxymaleate, bis(t-butylperoxy)isophthalate, methyl ethyl ketone peroxide, tert-butylperoxy-2-ethylhexanoate, diisopropyl peroxycarbonate, cumene hydroperoxide, 2,4-dichlorobenzoyl peroxide and tert-butyl-peroxypivalate.

Examples of the azo-based polymerization initiator include 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile and azobismethylbutyronitrile.

In addition, a redox-type initiator obtained by combining an oxidizing substance and a reducing substance may be used as the polymerization initiator. Examples of the oxidizing substance include: inorganic peroxides, such as hydrogen peroxide and persulfate salts (a sodium salt, a potassium salt and an ammonium salt); and an oxidizing metal salt such as a tetravalent cerium salt. Examples of the reducing substance include reducing metal salts (a divalent iron salt, a monovalent copper salt and a trivalent chromium salt), ammonia, lower amines (amines each having about 1 to about 6 carbon atoms, such as methylamine and ethylamine), an amino compound such as hydroxylamine, sodium thiosulfate, sodium hydrosulfite, sodium hydrogen sulfite, sodium sulfite, a reducing sulfur compound such as sodium formaldehyde sulfoxylate, lower alcohols (having 1 to 6 carbon atoms), ascorbic acid and salts thereof and lower aldehydes (having 1 to 6 carbon atoms).

The polymerization initiator is selected with reference to a 10-hour half-life temperature and the initiators are utilized alone or as a mixture thereof. Although the addition amount of the polymerization initiator varies depending on a target polymerization degree, the initiator is generally added in an amount of from 0.5 part to 20.0 parts by mass with respect to 100.0 parts by mass of the polymerizable monomer.

In addition, a known chain transfer agent and a known polymerization inhibitor may be further added and used for controlling a polymerization degree.

A known inorganic compound dispersion stabilizer and a known organic compound dispersion stabilizer may each be used as the dispersion stabilizer to be used at the time of the preparation of the aqueous medium. Examples of the inorganic compound dispersion stabilizer include tricalcium phosphate, magnesium phosphate, aluminum phosphate, zinc phosphate, calcium carbonate, magnesium carbonate, calcium hydroxide, magnesium hydroxide, aluminum hydroxide, calcium metasilicate, calcium sulfate, barium sulfate, bentonite, silica and alumina. Meanwhile, examples of the organic compound dispersion stabilizer include polyvinyl alcohol, gelatin, methyl cellulose, methylhydroxypropyl cellulose, ethyl cellulose, carboxymethyl cellulose sodium salt, polyacrylic acid and salts thereof and starch. The usage amount of those dispersion stabilizers is preferably from 0.2 part to 20.0 parts by mass with respect to 100.0 parts by mass of the polymerizable monomer.

When the inorganic compound dispersion stabilizer is used out of those dispersion stabilizers, a commercial product may be used as it is, but the inorganic compound may be produced in the aqueous medium for obtaining a dispersion stabilizer having a smaller particle diameter. In the case of, for example, tricalcium phosphate, the inorganic compound is obtained by mixing an aqueous solution of sodium phosphate and an aqueous solution of calcium chloride under high stirring.

In the present disclosure, the toner preferably includes an external additive externally added to the toner particle for an improvement in image quality. Inorganic fine powder, such as silica fine powder, titanium oxide fine powder or aluminum oxide fine powder, is suitably used as the external additive.

Such inorganic fine powder is preferably subjected to hydrophobic treatment with a hydrophobizing agent, such as a silane coupling agent, a silicone oil or a mixture thereof.

Further, in the toner of the present disclosure, an external additive except those described above may be mixed in the toner particle as required.

The total addition amount of the inorganic fine powder is preferably from 1.0 part to 5.0 parts by mass with respect to 100.0 parts by mass of the toner particle (toner particle before the addition of the external additive).

### [Methods of Measuring Various Physical Properties]

Methods of measuring various physical properties according to the present disclosure are described below.

### <Composition Analysis Method>

The structures of the pigment dispersant and the crystalline resin were determined with the following apparatus.

### ¹³C-NMR:

FT-NMR AVANCE-600 manufactured by Bruker BioSpin (used solvent: deuterated chloroform)

In the ¹³C-NMR, composition analysis was performed through quantification by an inverse gated decoupling method including using chromium(III) acetylacetonate as a relaxation reagent.

After the molar composition ratios of the respective monomer units of the pigment dispersant and the crystalline resin had been calculated by the above-mentioned measurement, the mass composition ratios thereof were determined from the molecular weights of the respective monomer units.

### <Method of Measuring Molecular Weight>

The weight-average molecular weight (Mw) of each of the toner and the pigment dispersant is measured by gel permeation chromatography (GPC) as described below.

A sample is dissolved in tetrahydrofuran (THF) at room temperature. Then, the resultant solution is filtered with a solvent-resistant membrane filter “Myshoridisk” (manufactured by Tosoh Corporation) having a pore diameter of 0.2 μm to provide a sample solution. The concentration of a THF-soluble component in the sample solution is adjusted to 0.8 mass %. Measurement is performed with the sample solution under the following conditions.
Apparatus: High-performance GPC Apparatus “HLC-8220 GPC” (manufactured by Tosoh Corporation)
Column: Duplicate of LF-604 (manufactured by Showa Denko K.K.)
Eluent: THF
Flow rate: 0.6 mL/min
Oven temperature: 40.0° C.
Sample injection amount: 0.020 ml

At the time of the calculation of the molecular weight of the sample, a molecular weight calibration curve prepared with standard polystyrene resins (e.g., product names “TSK Standard Polystyrenes F-850, F-450, F-288, F-128, F-80, F-40, F-20, F-10, F-4, F-2, F-1, A-5000, A-2500, A-1000 and A-500” each manufactured by Tosoh Corporation) is used.

### <Method of Measuring Polarity Parameters P1 and P2>

The polarity parameter P1 in the present disclosure was measured by the following method.

50 Milligrams (0.05 g) of the pigment dispersant is loaded into an 8-milliliter sample bottle and dissolved in 1.48 g of chloroform, followed by the measurement of the initial mass (W1) of the solution. A stirring bar is loaded into the sample bottle and (a) 100 mg (0.1 g) of acetonitrile is dropped into the solution while the solution is stirred with a magnetic stirrer, followed by the continuation of the stirring for 20 seconds. (b) Whether or not the mixture becomes clouded is visually observed. When the mixture does not become clouded, the operations (a) and (b) are repeatedly performed. At the point (precipitation point) at which the cloudiness is observed, the operations are stopped and the mass (W2) of the mixture is measured. All the measurements are performed at 25° C. and normal pressure.

The P1 is calculated in accordance with the following equation.
Initial mass before addition of acetonitrile: W1 (g)
Mass at cloudiness point after addition of acetonitrile: W2 (g)

$$Polarity parameter = \{ ( W 2 - W 1 ) / 0.78 \} / \{ ( ( W 2 - W 1 ) / 0.78 ) + 1 \}$$

The P2 is measured in the same manner except that in the above-mentioned measurement method, the pigment dispersant is changed to the crystalline resin.

### <Method of Measuring Melting Point>

The melting point of the pigment dispersant or the like is measured with a differential scanning calorimeter “Q1000” (manufactured by TA Instruments, Inc.) in conformity with ASTM D3418-82.

The melting points of indium and zinc are used for the temperature correction of the detecting portion of the calorimeter and the heat of fusion of indium is used for heat quantity correction.

Specifically, 5 mg of a sample is precisely weighed and the sample is loaded into a pan made of aluminum. An empty pan made of aluminum is used as a reference and the melting point of the sample is measured in the measurement temperature range of from 0° C. to 150° C. at a rate of temperature increase of 10° C./min. In the measurement, the temperature of the sample is increased to 150° C. once and subsequently decreased to 0° C., followed by the performance of a temperature increase again. The peak temperature of the maximum endothermic peak of a DSC curve in the temperature range of from 0° C. to 150° C. in the second temperature increase process is defined as the melting point of the sample.

### <Observation of Matrix-Domain Structure in Section of Toner>

The state of presence of the matrix-domain structure (sea-island structure) in the section of the toner is recognized by observing the section of the toner with a scanning transmission electron microscope. The observation of the section of the toner is performed after the performance of ruthenium staining. That is, the sectional image of the toner is a sectional image of the toner subjected to the ruthenium staining. A procedure for the observation of the section of the toner is as described below.

The toner is embedded in a visible light-curable resin (D-800, manufactured by Nisshin-EM) so that a state in which the toner is dispersed therein to the extent possible may be established, followed by the cutting of the embedded product into a thickness of 100 nm with an ultrasonic ultramicrotome (UC7, manufactured by Leica Camera AG).

The resultant flaky sample is stained with a vacuum staining apparatus (VSC4R1H, manufactured by Filgen, Inc.) in a RuO₄ gas atmosphere at 500 Pa for 15 minutes and a STEM image thereof is taken with a scanning transmission electron microscope (JEM-2800, JEOL Ltd.). In the above-mentioned staining conditions, a difference in degree of staining occurs between the crystalline resin and the amorphous resin and hence the state of presence of the matrix-domain structure can be recognized by the contrast difference.

Observation conditions are as follows: an acceleration voltage, a STEM probe size, an image size and a magnification are set to 200 kV, 1 nm, 1,024×1,024 pixels and 30,000, respectively; and a dark field (STEM-DF) image is taken.

The contrast and brightness of the microscope are adjusted so that in a brightness histogram obtained with the following ImageJ, a brightness when a portion containing a resin component as a main component has the maximum number of pixels may be 150.

When the brightness is from 140 to 160, the brightness may be adjusted with Microsoft Photo.

### <Method of Measuring Weight-Average Particle Diameter (D4) and Number-Average Particle Diameter (DI) of Toner Particles>

A precision particle size distribution-measuring apparatus based on a pore electrical resistance method (product name: Coulter Counter Multisizer 3) and dedicated software (product name: Beckman Coulter Multisizer 3 Version 3.51, manufactured by Beckman Coulter, Inc.) are used. An aperture diameter of 100 μm is used and measurement is performed at a number of effective measurement channels of 25,000, followed by the analysis of measurement data to calculate the weight-average particle diameter (D4) and number-average particle diameter (DI) of the toner particles. An electrolyte aqueous solution prepared by dissolving special-grade sodium chloride in ion-exchanged water so as to have a concentration of 1% by mass, such as ISOTON II (product name) manufactured by Beckman Coulter, Inc., may be used in the measurement. The dedicated software is set as described below prior to the measurement and the analysis.

In the “change standard measurement method (SOM)” screen of the dedicated software, the total count number of a control mode is set to 50,000 particles, the number of times of measurement is set to 1 and a value obtained by using standard particles each having a particle diameter of 10.0 μm (manufactured by Beckman Coulter, Inc.) is set as a Kd value. A threshold and a noise level are automatically set by pressing a threshold/noise level measurement button. In addition, a current is set to 1,600 μA, a gain is set to 2, an electrolyte solution is set to ISOTON II (product name) and a check mark is placed in a check box as to whether the aperture tube is flushed after the measurement.

In the “setting for conversion from pulse to particle diameter” screen of the dedicated software, a bin interval is set to a logarithmic particle diameter, the number of particle diameter bins is set to 256 and a particle diameter range is set to the range of from 2 μm to 60 μm.

A specific measurement method is as described below.
(1) 200 mL of the electrolyte aqueous solution is charged into a 250 mL round-bottom beaker made of glass dedicated for the Multisizer 3. The beaker is set in a sample stand and the electrolyte aqueous solution in the beaker is stirred with a stirrer rod at 24 rotations/sec in a counterclockwise direction. Then, dirt and bubbles in the aperture tube are removed by the “aperture flush” function of the analysis software.
(2) 30 mL of the electrolyte aqueous solution is charged into a 100 mL flat-bottom beaker made of glass. 0.3 mL of a diluted solution prepared by diluting Contaminon N (product name) (a 10% by mass aqueous solution of a neutral detergent for washing a precision measuring device, manufactured by Wako Pure Chemical Industries, Ltd.) with ion-exchanged water by three mass fold is added to the electrolyte aqueous solution.
(3) A predetermined amount of ion-exchanged water and 2 mL of Contaminon N (product name) are added into the water tank of an ultrasonic dispersing unit (product name: Ultrasonic Dispersion System Tetra 150, manufactured by Nikkaki Bios Co., Ltd.) having an electrical output of 120 W in which two oscillators each having an oscillatory frequency of 50 kHz are built so as to be under the state of being out of phase by 180°.
(4) The beaker in the section (2) is set in the beaker fixing hole of the ultrasonic dispersing unit and the ultrasonic dispersing unit is operated. Then, the height position of the beaker is adjusted in order that the liquid surface of the electrolyte aqueous solution in the beaker may resonate with an ultrasonic wave from the ultrasonic dispersing unit to the fullest extent possible.
(5) 10 mg of the toner (particles) is gradually added to and dispersed in the electrolyte aqueous solution in the beaker in the section (4) under a state in which the electrolyte aqueous solution is irradiated with the ultrasonic wave. Then, the ultrasonic dispersion treatment is continued for an additional 60 seconds. The temperature of water in the water tank is appropriately adjusted to from 10° C. to 40° C. in the ultrasonic dispersion.
(6) The electrolyte aqueous solution in the section (5) in which the toner (particles) has been dispersed is added dropwise with a pipette to the round-bottom beaker in the section (1) placed in the sample stand and the concentration of the particles to be measured is adjusted to 5%. Then, measurement is performed until the particle diameters of 50,000 particles are measured.
(7) The measurement data is analyzed with the dedicated software included with the apparatus and the weight-average particle diameter (D4) is calculated. An “average diameter” on the “analysis/volume statistics (arithmetic average)” screen of the dedicated software when the dedicated software is set to show a graph in a vol % unit is the weight-average particle diameter (D4). An “average diameter” on the “analysis/number statistics (arithmetic average)” screen thereof when the dedicated software is set to show a graph in a number % unit is the number-average particle diameter (DI).

### EXAMPLES

The present disclosure is specifically described by way of Production Examples and Examples described below. However, the present disclosure is by no means limited by those examples. The terms “part(s)” and “%” in Production Examples and Examples mean “part(s) by mass” and “% by mass,” respectively unless otherwise stated.

### Production Example of Polymer Moiety (P-1)

100.0 Parts of xylene, 69.9 parts of behenyl acrylate, 28.4 parts of styrene, 1.7 parts of methacrylic acid were loaded into a reaction vessel and the temperature of the reaction vessel was retained at 70° C. while nitrogen purging was performed. After that, a solution obtained by dissolving 1.5 parts of dimethyl azobis(isobutyrate) serving as a polymerization initiator in 1.0 part of xylene was dropped into the reaction vessel over 3 hours. After the completion of the dropping, polymerization was performed by retaining the reaction vessel at 70° C. for 3 hours. After that, a liquid temperature was increased to 170° C. and distillation was performed under a reduced pressure of 1 hPa for 3 hours, to thereby remove the solvent. Thus, Polymer Moiety (P-1) was obtained.

### Production Examples of Polymer Moieties (P-2) to (P-18)

Polymer Moieties (P-2) to (P-18) were each obtained in the same manner as in the case of Polymer Moiety (P-1) except that, in Production Example of Polymer Moiety (P-1), the raw materials were changed as shown in Table 1. The composition ratios of Polymer Moieties (P-2) to (P-18) are shown in Table 1.

TABLE 1
Composition ratios of Polymer Moieties

| | Number of monomer parts | | | | | | Number of |
|---|---|---|---|---|---|---|---|
| | X | Y | | | | Z | polymerization |
| | BEA | St | MA | LMA | 2-MTA | MAA | initiator parts |
| P-1 | 69.9 | 28.4 | | | | 1.7 | 1.5 |
| P-2 | 76.5 | 23.0 | | | | 0.5 | 3.4 |
| P-3 | 59.8 | 38.0 | | | | 2.2 | 0.9 |
| P-4 | 81.4 | 16.4 | | | | 2.2 | 1.2 |
| P-5 | 56.2 | 43.3 | | | | 0.5 | 1.6 |
| P-6 | 80.7 | 1.9 | | | 17.0 | 0.3 | 6.1 |
| P-7 | 56.0 | 27.6 | | 12.2 | 0.0 | 4.2 | 0.8 |
| P-8 | 47.7 | 26.5 | 25.5 | | | 0.3 | 2.3 |
| P-9 | 87.8 | 9.5 | | | | 2.7 | 1.9 |
| P-10 | 60.2 | 37.1 | | | | 2.7 | 0.9 |
| P-11 | 59.8 | 38.0 | | | | 2.2 | 0.9 |
| P-12 | 47.7 | 51.9 | | | | 0.4 | 2.4 |
| P-13 | 80.4 | 1.9 | | | 17.5 | 0.2 | 6.1 |
| P-14 | 56.2 | 21.4 | 17.4 | | | 5.0 | 0.8 |
| P-15 | 20.4 | 77.4 | | | | 2.2 | 0.9 |
| P-16 | 45.5 | 52.2 | | | | 2.3 | 1.1 |
| P-17 | 80.7 | 1.9 | | | 17.0 | 0.3 | 6.7 |
| P-18 | 56.0 | 27.6 | | 12.2 | | 4.2 | 0.7 |

BEA: behenyl acrylate
St: styrene
MA: methyl acrylate
LMA: lauryl methacrylate
2-MTA: 2-methoxyethyl acrylate
MAA: methacrylic acid

### Production Example of Pigment Adsorption Moiety Precursor (A-1)

First, 25.0 parts of m-nitroaniline, 15.4 parts of diketene and 15.0 parts of acetone were added to 140 parts of acetic acid and the contents were stirred at 65° C. for 3 hours. After the completion of the reaction, the resultant was poured into 1,200 parts of water, followed by filtration. Thus, 38.4 parts of Compound (1) was obtained (yield: 96.0%).

Next, 142 parts of N,N-dimethylformamide and 30.8 parts of concentrated hydrochloric acid were added to 15.0 parts of 5-amino-2-benzimidazolinone and the mixture was ice-cooled to 5° C. or less. A solution of 7.25 parts of sodium nitrite dissolved in 50.0 parts of water was added to the solution and the mixture was stirred at the same temperature for 1 hour (diazonium salt solution). 21.9 Parts of Compound (1) and 68.4 parts of calcium carbonate were added to 142 parts of N,N-dimethylformamide and the mixture was ice-cooled to 5° C. or less. The above-mentioned diazonium salt solution was added thereto and the mixture was subjected to a reaction at 5° C. or less for 3 hours. After the reaction, the reaction liquid was filtered and the solvent was evaporated under reduced pressure. The precipitate was washed with dilute hydrochloric acid, water and methanol. Thus, 36.0 parts of Compound (2) was obtained (yield: 94.3%).

Compound (2) thus obtained was added to 203 parts of 1,4-dioxane and a solution of 12.4 parts of sodium hydrosulfide dissolved in 80 parts of water was dropped thereinto under room temperature. After the dropping, the solution was increased in temperature and stirred at 50° C. for 26 hours. After the completion of the reaction, the reaction liquid was poured into water and the precipitate was filtered out and washed with dilute hydrochloric acid, water and methanol. Thus, 10.0 parts of Pigment Adsorption Moiety Precursor (A-1) (Compound (3) was obtained (yield: 50.6%). The structure of Pigment Adsorption Moiety Precursor (A-1) is shown in Table 2.

### Production Examples of Pigment Adsorption Moiety Precursors (A-2) and (A-3)

Pigment Adsorption Moiety Precursors (A-2) and (A-3) were each obtained in the same manner as in the case of Pigment Adsorption Moiety Precursor (A-1) except that, in Production Example of Pigment Adsorption Moiety Precursor (A-1), the compounds to be used and the like were changed so that the composition shown in Table 2 was obtained.

TABLE 2
Production Example of Pigment Adsorption Moiety Precursor

| | R₁ | R₂ | R₃ | R₄ | R₅ | R₆ | R₇ | R₈ | R₉ | R₁₀ | R₁₁ |
|---|---|---|---|---|---|---|---|---|---|---|---|
| A-1 | —CH₃ | —H | —NH₂ | —H | —H | —H | —H | —NHCONH— | | —H | —H |
| A-2 | —CH₃ | —H | —NH₂ | —H | —H | —H | —H | —H | —H | —H | —H |

| | | | | | | | | | | |
|---|---|---|---|---|---|---|---|---|---|---|
| A-3 | —C₂H₅ | —H | —NHCONH— | —H | —H | —H | —H | —NH₂ | —H | —H |

### Production Example of Pigment Dispersant Sy-1

10.0 Parts of Polymer Moiety (P-1) was dissolved in 100 parts of chloroform and 1.5 parts of thionyl chloride was dropped thereinto. The contents were stirred at room temperature for 24 hours. After that, the reaction liquid was concentrated so that chloroform and excessive thionyl chloride were removed. The resultant resin solid material was collected and was dissolved again in 60.0 parts of N,N-dimethylacetamide at 70° C.′ under a nitrogen atmosphere. 1.5 Parts of Pigment Adsorption Moiety Precursor (A-1) was added thereto and the mixture was stirred at 70° C. under a nitrogen atmosphere for 3 hours. After the completion of the reaction, the reaction liquid was concentrated and was then reprecipitated with methanol. Thus, 9.87 parts of Pigment Dispersant Sy-1 was obtained.

The composition and physical properties (weight-average molecular weight (Mw), melting point (Tm) and polarity parameter P1) of Pigment Dispersant Sy-1 thus obtained are shown in Tables 3-1 and 3-2.

The structural formula of Pigment Dispersant Sy-1 is represented by the following formula, in which R₁₇ in the formula (4) represents a carboxylic acid amide bond (—CONH—) serving as a linking group and is bonded to the polymer moiety.

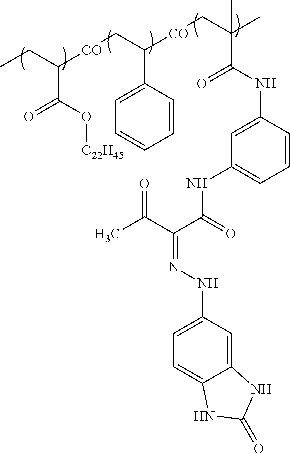

### Production Examples of Pigment Dispersants Sy-2 to Sy-18

Pigment dispersants (Sy-2) to (Sy-18) were each obtained in the same manner as in the pigment dispersant (Sy-1) except that in the production example of the pigment dispersant (Sy-1), the kinds and amounts of the materials were changed so that composition shown in Tables 3-1 and 3-2 was obtained. The composition and physical properties of each of the pigment dispersants (Sy-2) to (Sy-18) are shown in Tables 3-1 and 3-2.

TABLE 3-1
Composition and physical properties of pigment dispersants

| | | Pigment | | | |
|---|---|---|---|---|---|
| | | adsorption | | | |
| | Polymer | site | Compositions (% by mass) | | |
| | site | precursor | Formula (3) | Formula (1) | Other |
| Sy-1 | P-1 | A-1 | 65.5 | 6.2 | 28.3 |
| Sy-2 | P-2 | A-1 | 74.9 | 2.0 | 23.1 |
| Sy-3 | P-3 | A-1 | 55.0 | 8.0 | 37.0 |
| Sy-4 | P-4 | A-1 | 74.9 | 8.0 | 17.1 |
| Sy-5 | P-5 | A-1 | 55.1 | 2.0 | 42.9 |
| Sy-6 | P-6 | A-1 | 79.7 | 1.3 | 19.0 |
| Sy-7 | P-7 | A-1 | 48.1 | 14.1 | 37.8 |
| Sy-8 | P-8 | A-1 | 47.0 | 1.4 | 51.6 |
| Sy-9 | P-9 | A-1 | 79.4 | 9.6 | 11.0 |
| Sy-10 | P-10 | A-2 | 55.4 | 8.0 | 36.6 |
| Sy-11 | P-11 | A-3 | 55.0 | 8.0 | 37.0 |
| Sy-12 | P-12 | A-1 | 47.0 | 1.4 | 51.6 |
| Sy-13 | P-13 | A-1 | 79.8 | 0.8 | 19.4 |
| Sy-14 | P-14 | A-1 | 47.0 | 16.5 | 36.5 |
| Sy-15 | P-15 | A-1 | 18.8 | 8.0 | 73.2 |
| Sy-16 | P-16 | A-1 | 41.8 | 8.3 | 49.9 |
| Sy-17 | P-17 | A-1 | 79.7 | 1.3 | 19.0 |
| Sy-18 | P-18 | A-1 | 48.1 | 14.1 | 37.8 |

TABLE 3-2
Composition and physical properties of pigment dispersants

| | | | | Physical properties | | |
|---|---|---|---|---|---|---|
| | Compositions (mol %) | | | | | Polarity |
| | Formula | Formula | | TM | | parameter |
| | (3) | (1) | Other | (° C.) | Mw | P1 |
| Sy-1 | 35.8 | 4.0 | 60.2 | 60 | 30000 | 0.30 |
| Sy-2 | 45.0 | 1.4 | 53.6 | 61 | 15000 | 0.18 |
| Sy-3 | 26.4 | 4.5 | 69.1 | 58 | 45000 | 0.37 |
| Sy-4 | 49.4 | 6.2 | 44.4 | 61 | 45000 | 0.30 |
| Sy-5 | 24.7 | 1.1 | 74.3 | 58 | 25000 | 0.26 |
| Sy-6 | 56.2 | 1.1 | 42.7 | 54 | 11000 | 0.20 |
| Sy-7 | 25.4 | 8.8 | 65.8 | 55 | 48000 | 0.48 |
| Sy-8 | 18.7 | 1.0 | 80.3 | 53 | 15000 | 0.28 |
| Sy-9 | 58.8 | 8.3 | 32.9 | 61 | 30000 | 0.33 |
| Sy-10 | 26.4 | 5.5 | 68.2 | 58 | 45000 | 0.30 |
| Sy-11 | 26.4 | 4.5 | 69.1 | 58 | 45000 | 0.35 |
| Sy-12 | 18.9 | 1.2 | 79.9 | none | 15000 | 0.20 |
| Sy-13 | 56.1 | 0.7 | 43.2 | 60 | 10000 | 0.19 |
| Sy-14 | 26.5 | 11.0 | 62.6 | 55 | 48000 | 0.50 |
| Sy-15 | 6.0 | 3.0 | 91.0 | none(T g | 30000 | 0.81 |
| | | | | 58) | | |
| Sy-16 | 17.0 | 4.0 | 79.0 | none | 30000 | 0.18 |
| Sy-17 | 56.2 | 1.1 | 42.7 | 48 | 8000 | 0.20 |
| Sy-18 | 25.4 | 8.8 | 65.8 | 55 | 55000 | 0.48 |

### Production Example of Crystalline Resin C-1

Under a nitrogen atmosphere, the following materials were loaded into a reaction vessel including a reflux condenser, a stirring machine, a temperature gauge and a nitrogen-introducing tube.

| | | |
|---|---|---|
| Toluene | 100.0 | parts |
| Behenyl acrylate | 80.0 | parts |
| Styrene | 20.0 | parts |
| t-Butyl peroxypivalate (manufactured by NOF Corporation: | 0.5 | part |
| PERBUTYL PV) serving as a polymerization initiator | | |

While the materials in the reaction vessel were stirred at 200 rpm, the materials were heated to 70° C. and subjected to a polymerization reaction for 12 hours. Thus, such a dissolved liquid that the polymer of a monomer composition was dissolved in toluene was obtained. After that, toluene and the remaining monomers were evaporated at 160° C. and 1 hPa. Thus, a crystalline resin C-1 was obtained.

### Production Example of Crystalline Resin C-2

A crystalline resin C-2 was obtained in the same manner as in the crystalline resin C-1 except that in the preparation of the crystalline resin C-1, the materials were changed to 60.0 parts of behenyl acrylate, 15 parts of styrene and 25 parts of methacrylonitrile.

### Production Example of Crystalline Resin C-3

118.0 Parts of sebacic acid and 69.0 parts of 1,6-hexanediol were added to a reaction vessel including a stirring machine, a temperature gauge, a nitrogen-introducing tube, a dewatering tube and a decompressor and the mixture was heated to a temperature of 130° C. while being stirred. After 0.7 part of titanium(IV) isopropoxide had been added as an esterification catalyst to the mixture, the temperature of the mixture was increased to 160ºC and the mixture was subjected to condensation polymerization over 5 hours. After that, the temperature of the resultant was increased to 180ºC and while a pressure in the vessel was reduced, the resultant was subjected to a reaction until a desired molecular weight was obtained. Thus, a crystalline resin C-3 was obtained.

### Production Example of Crystalline Resin C-4

118.0 Parts of sebacic acid and 69.0 parts of 1,6-hexanediol were added to a reaction vessel including a stirring machine, a temperature gauge, a nitrogen-introducing tube, a dewatering tube and a decompressor and the mixture was heated to a temperature of 130° C. while being stirred. After 0.7 parts by mass of titanium(IV) isopropoxide had been added to the mixture, the temperature of the mixture was increased to 160° C. and the mixture was subjected to condensation polymerization over 5 hours. Next, 7.0 parts by mass of acrylic acid and 50.0 parts by mass of styrene were dropped into the vessel over 1 hour. While the temperature of the mixture was held at 160ºC, the mixture was continuously stirred for 1 hour and then the monomer of a styrene resin component was removed at 8.3 kPa for 1 hour. After that, the temperature of the residue was increased to 210° C. and the residue was subjected to a reaction until a desired molecular weight was obtained. Thus, a crystalline resin C-4 was obtained.

The composition and physical properties (Weight-average molecular weight (Mw) and Polarity parameter P2) of each of the crystalline resins C-1 to C-4 are shown in Table 4.

TABLE 4
Composition and physical properties of crystalline resins

| | | | | | | | Molecular | Polarity |
|---|---|---|---|---|---|---|---|---|
| | | | | | | | weight | parameter |
| | Composition (% by mass) | | | | | | (Mw) | P2 |
| C-1 | Behenyl acrylate | 80.0 | Styrene | 20.0 | | | 30000 | 0.28 |
| C-2 | Behenyl acrylate | 60.0 | Styrene | 15.0 | Methacrylonitrile | 25.0 | 28000 | 0.40 |
| C-3 | Sebacic acid | 63.0 | 1-6 Hexandiol | 37.0 | | | 30000 | 0.38 |
| C-4 | Sebacic acid | 56.7 | 1-6 Hexandiol | 33.3 | Styrene | 10.0 | 26000 | 0.42 |

### Production Example of Black Toner 1

### [Step of Preparing Colorant Dispersion 1]

| | | |
|---|---|---|
| Styrene monomer | 100.0 | parts |
| Carbon Black (CB) | 20.0 | parts |
| (Nipex 35: manufactured by Orion Engineered Carbons) | 2.0 | parts |
| Pigment dispersant Sy-1 | | |

The above-mentioned materials were introduced into an attritor (manufactured by Mitsui Mining Co., Ltd.) and were stirred with zirconia beads (200 parts) each having a radius of 2.5 mm at 200 rpm and 25° C. for 180 minutes to prepare a colorant dispersion liquid 1.

### [Step of Preparing Toner Composition-Dissolved Liquid]

| | | |
|---|---|---|
| Colorant dispersion liquid 1 | 48.8 | parts |
| Styrene | 4.0 | parts |
| n-Butyl acrylate (BA) | 19.0 | parts |
| Crystaline resin C-1 | 35.0 | parts |
| Dipentaerythritol hexastearate | 10.0 | parts |

The above-mentioned materials were mixed and the temperature of the mixture was warmed to 65° C., followed by uniform dissolution and dispersion with a TK-type homomixer (manufactured by Tokushu Kika Kogyo Co., Ltd.) at 5,000 rpm for 60 minutes. Thus, a toner composition-dissolved liquid 1 was obtained.

### [Step of Preparing Dispersion Liquid (Aqueous Medium)]

In a 2-liter four-necked flask including a high-speed stirring device TK HOMOMIXER, 450 parts of a 0.1 M aqueous solution of Na₃PO₄ was loaded into 710 parts of ion-exchanged water and the temperature of the mixture was warmed to 60° C. After that, 67.7 parts of a 1.0 M aqueous solution of CaCl₂ was gradually added to the mixture to provide an aqueous medium 1 containing a calcium phosphate compound.

### [Granulating Step]

While the temperature of the aqueous medium 1 and the number of revolutions of the stirring device were kept at 60° C. and 12,500 rpm, respectively, the toner composition-dissolved liquid 1 was loaded into the aqueous medium 1 and 9.0 parts of t-butylperoxypivalate serving as a polymerization initiator was added to the mixture. The mixture was granulated as it was with the stirring device for 10 minutes while its number of revolutions was maintained at 12,500 rpm.

### [Polymerizing Step]

The high-speed stirring device was changed to a stirring machine including a propeller stirring blade and the granulated product was held at 70° C. and was polymerized for 5.0 hours while being stirred at 200 rpm. After that, the temperature of the resultant was increased to 98° C. and the resultant was heated for 3.0 hours so that the remaining monomers were removed. Thus, a black toner particle dispersion liquid having dispersed therein black toner particles 1 was obtained.

Hydrochloric acid was added to the resultant black toner particle 1 dispersion liquid to set its pH to 1.4 and the mixture was stirred for 1 hour so that the calcium phosphate salt was dissolved. The solution was subjected to solid-liquid separation with a pressure filter under a pressure of 0.4 MPa to provide a toner cake. Next, ion-exchanged water was added to the pressure filter until the filter was filled with the water, followed by the washing of the cake at a pressure of 0.4 MPa. The washing operation was repeated three times and then the washed product was dried to provide black toner particles 1. The weight-average particle diameter (D4) of the resultant black toner particles 1 was 6.9 μm.

1.5 Parts of hydrophobic silica fine powder (number-average primary particle diameter: 10 nm) subjected to surface treatment with hexamethyldisilazane was added to 100.0 parts of the resultant black toner particles 1 and a mixing step was performed with a Henschel mixer (manufactured by Mitsui Mining Co., Ltd.) for 300 seconds to provide a black toner 1. The composition and physical properties of the black toner 1 are shown in Tables 5-1 to 5-4.

### Production Examples of Black Toners 2 to 27

Black toners 2 to 27 were each obtained in the same manner as in the production example of the black toner 1 except that the composition of the black toner particles 1 was changed as shown in Tables 5-1 to 5-4. The composition and physical properties of each of the black toners 2 to 27 are shown in Tables 5-1 to 5-4.

TABLE 5-1
Composition and Physical properties of Black toners 1 to 15

| | Composition of Toners | | | | | | | |
|---|---|---|---|---|---|---|---|---|
| | | | | | | | Wax | |
| | Binding resin | | | | | | | Molecular |
| | | | Crystalline | | | Pigment | | weight |
| | Styrene | BA | Resin | | Pigment | Dispersant | Type | (Mn) |
| Black toner 1 | 46.0 | 19.0 | C-1 | 35.0 | CB | Sy-1 | Dipentaerythritol | 1850 |
| | | | | | | | hexastearate | |
| Black toner 2 | 35.0 | 15.0 | C-1 | 50.0 | CB | Sy-1 | Dipentaerythritol | 1850 |
| | | | | | | | hexastearate | |
| Black toner 3 | 56.5 | 23.5 | C-1 | 20.0 | CB | Sy-1 | Dipentaerythritol | 1850 |
| | | | | | | | hexastearate | |
| Black toner 4 | 46.0 | 19.0 | C-1 | 35.0 | CB | Sy-2 | Dipentaerythritol | 1850 |
| | | | | | | | hexastearate | |
| Black toner 5 | 46.0 | 19.0 | C-1 | 35.0 | CB | Sy-3 | Dipentaerythritol | 1850 |
| | | | | | | | hexastearate | |
| Black toner 6 | 46.0 | 19.0 | C-1 | 35.0 | CB | Sy-4 | Dipentaerythritol | 1850 |
| | | | | | | | hexastearate | |
| Black toner 7 | 46.0 | 19.0 | C-1 | 35.0 | CB | Sy-5 | Dipentaerythritol | 1850 |
| | | | | | | | hexastearate | |
| Black toner 8 | 46.0 | 19.0 | C-1 | 35.0 | CB | Sy-6 | Dipentaerythritol | 1850 |
| | | | | | | | hexastearate | |
| Black toner 9 | 46.0 | 19.0 | C-1 | 35.0 | CB | Sy-7 | Dipentaerythritol | 1850 |
| | | | | | | | hexastearate | |
| Black toner 10 | 46.0 | 19.0 | C-2 | 35.0 | CB | Sy-7 | Dipentaerythritol | 1850 |
| | | | | | | | hexastearate | |
| Black toner 11 | 46.0 | 19.0 | C-1 | 35.0 | CB | Sy-8 | Dipentaerythritol | 1850 |
| | | | | | | | hexastearate | |
| Black toner 12 | 46.0 | 19.0 | C-1 | 35.0 | CB | Sy-9 | Dipentaerythritol | 1850 |
| | | | | | | | hexastearate | |
| Black toner 13 | 46.0 | 19.0 | C-1 | 35.0 | CB | Sy-10 | Dipentaerythritol | 1850 |
| | | | | | | | hexastearate | |
| Black toner 14 | 46.0 | 19.0 | C-1 | 35.0 | CB | Sy-11 | Dipentaerythritol | 1850 |
| | | | | | | | hexastearate | |
| Black toner 15 | 46.0 | 19.0 | C-1 | 35.0 | CB | Sy-12 | Dipentaerythritol | 1850 |
| | | | | | | | hexastearate | |

TABLE 5-2
Composition and Physical properties of Black toners 16 to 27

| | Composition of Toners | | | | | | | |
|---|---|---|---|---|---|---|---|---|
| | | | | | | | Wax | |
| | Binding resin | | | | | | | Molecular |
| | | | Crystalline | | | Pigment | | weight |
| | Styrene | BA | Resin | | Pigment | Dispersant | Type | (Mn) |
| Black toner 16 | 46.0 | 19.0 | C-3 | 35.0 | CB | Sy-3 | Dipentaerythritol | 1850 |
| | | | | | | | hexastearate | |
| Black toner 17 | 46.0 | 19.0 | C-4 | 35.0 | CB | Sy-3 | Dipentaerythritol | 1850 |
| | | | | | | | hexastearate | |
| Black toner 18 | 46.0 | 19.0 | C-1 | 35.0 | CB | Sy-3 | Hydrocarbon wax | 480 |
| Black toner 19 | 46.0 | 19.0 | C-1 | 35.0 | CB | Sy-3 | Tripentaerythritol | 2950 |
| | | | | | | | octabehenate | |
| Black toner 20 | 46.0 | 19.0 | C-1 | 35.0 | CB | Sy-3 | Ethylene glycol | 700 |
| | | | | | | | distearate | |
| Black toner 21 | 46.0 | 19.0 | C-1 | 35.0 | CB | Sy-13 | Dipentaerythritol | 1850 |
| | | | | | | | hexastearate | |
| Black toner 22 | 46.0 | 19.0 | C-2 | 35.0 | CB | Sy-14 | Dipentaerythritol | 1850 |
| | | | | | | | hexastearate | |
| Black toner 23 | 46.0 | 19.0 | C-1 | 35.0 | CB | Sy-15 | Dipentaerythritol | 1850 |
| | | | | | | | hexastearate | |
| Black toner 24 | 46.0 | 19.0 | C-1 | 35.0 | CB | Sy-16 | Dipentaerythritol | 1850 |
| | | | | | | | hexastearate | |
| Black toner 25 | 46.0 | 19.0 | C-1 | 35.0 | CB | Sy-17 | Dipentaerythritol | 1850 |
| | | | | | | | hexastearate | |
| Black toner 26 | 46.0 | 19.0 | C-1 | 35.0 | CB | Sy-18 | Dipentaerythritol | 1850 |
| | | | | | | | hexastearate | |
| Black toner 27 | 64.0 | 24.0 | C-1 | 10.0 | CB | Sy-1 | Dipentaerythritol | 1850 |
| | | | | | | | hexastearate | |

TABLE 5-3
Composition and Physical properties of Black toners 1 to 15

| | Physical properties of Toners | | | | |
|---|---|---|---|---|---|
| | | | Particle | Molecular | |
| | Cross-section of toner | | diameter | weight | |
| | Matrix | Domain | (D4) μm | (Mw) | \|P1-P2\| |
| Black | C-1 StBA | StBA Resin | 6.9 | 58000 | 0.02 |
| toner 1 | Resin | | | | |
| Black | C-1 StBA | StBA Resin | 7.2 | 52000 | 0.02 |
| toner 2 | Resin | | | | |
| Black | C-1 StBA | StBA Resin | 6.5 | 55000 | 0.02 |
| toner 3 | Resin | | | | |
| Black | C-1 StBA | StBA Resin | 6.8 | 55000 | 0.10 |
| toner 4 | Resin | | | | |
| Black | C-1 StBA | StBA Resin | 6.9 | 57000 | 0.09 |
| toner 5 | Resin | | | | |
| Black | C-1 StBA | StBA Resin | 7.0 | 55000 | 0.02 |
| toner 6 | Resin | | | | |
| Black | C-1 StBA | StBA Resin | 6.9 | 54000 | 0.02 |
| toner 7 | Resin | | | | |
| Black | C-1 StBA | StBA Resin | 6.8 | 52000 | 0.08 |
| toner 8 | Resin | | | | |
| Black | C-1 StBA | StBA Resin | 6.8 | 53000 | 0.20 |
| toner 9 | Resin | | | | |
| Black | C-2 StBA | StBA Resin | 6.9 | 56000 | 0.08 |
| toner 10 | Resin | | | | |
| Black | C-1 StBA | StBA Resin | 7.1 | 57000 | 0.00 |
| toner 11 | Resin | | | | |
| Black | C-1 StBA | StBA Resin | 7.0 | 54000 | 0.05 |
| toner 12 | Resin | | | | |
| Black | C-1 StBA | StBA Resin | 6.8 | 55000 | 0.02 |
| toner 13 | Resin | | | | |
| Black | C-1 StBA | StBA Resin | 6.9 | 53000 | 0.07 |
| toner 14 | Resin | | | | |
| Black | C-1 StBA | StBA Resin | 6.9 | 56000 | 0.08 |
| toner 15 | Resin | | | | |

StBA Resin: Styrene-Butyl acrylate Resin

TABLE 5-4
Composition and Physical properties of Black toners 16 to 27

| | Physical properties of Toners | | | | |
|---|---|---|---|---|---|
| | | | Particle | Molecular | |
| | Cross-section of toner | | diameter | weight | |
| | Matrix | Domain | (D4) μm | (Mw) | \|P1-P2\| |
| Black | StBA Resin | C-3 | 7.0 | 56000 | 0.01 |
| toner 16 | | | | | |
| Black | C-4 StBA | StBA Resin | 7.0 | 54000 | 0.09 |
| toner 17 | Resin | | | | |
| Black | C-1 StBA | StBA Resin | 6.7 | 56000 | 0.02 |
| toner 18 | Resin | | | | |
| Black | C-1 StBA | StBA Resin | 6.8 | 55000 | 0.02 |
| toner 19 | Resin | | | | |
| Black | C-1 StBA | StBA Resin | 6.9 | 54000 | 0.02 |
| toner 20 | Resin | | | | |
| Black | C-1 StBA | StBA Resin | 6.8 | 56000 | 0.09 |
| toner 21 | Resin | | | | |
| Black | C-2 StBA | StBA Resin | 6.7 | 54000 | 0.10 |
| toner 22 | Resin | | | | |
| Black | C-1 StBA | StBA Resin | 6.9 | 55000 | 0.53 |
| toner 23 | Resin | | | | |
| Black | C-1 StBA | StBA Resin | 6.9 | 56000 | 0.10 |
| toner 24 | Resin | | | | |
| Black | C-1 StBA | StBA Resin | 6.7 | 53000 | 0.08 |
| toner 25 | Resin | | | | |
| Black | C-1 StBA | StBA Resin | 7.0 | 57000 | 0.20 |
| toner 26 | Resin | | | | |
| Black | StBA Resin | C-1 | 7.1 | 52000 | 0.02 |
| toner 27 | | | | | |

StBA Resin: Styrene-Butyl acrylate Resin

### Production Example of Magenta Toner 1

### [Step of Preparing Colorant Dispersion Liquid 2]

| | | |
|---|---|---|
| Styrene monomer | 100.0 | parts |
| Pigment Red 122 (PR-122) | 12.5 | parts |
| (Toner Magenta E [manufactured by Clariant]) | | |
| Pigment Red 150 (PR-150) (Fuji Fast Carmine 522 | 7.5 | parts |
| [manufactured by Fuji Pigment Co., Ltd.]) | | |
| Pigment dispersant (Sy-1) | 2.0 | parts |

The above-mentioned materials were introduced into an attritor (manufactured by Mitsui Mining Co., Ltd.) and were stirred with zirconia beads (200 parts) each having a radius of 2.5 mm at 200 rpm and 25° C. for 180 minutes to prepare a colorant dispersion liquid 2.

From then on, a magenta toner 1 was obtained in the same manner as in the black toner 1. The composition and physical properties of the resultant magenta toner 1 are shown in Tables 6-1 and 6-2.

### Production Examples of Magenta Toners 2 to 5

Magenta toners 2 to 5 were each obtained in the same manner as in the production example of the magenta toner 1 except that the pigment dispersant of the magenta toner 1 was changed as shown in Tables 6-1 and 6-2. The composition and physical properties of each of the magenta toners 2 to 5 are shown in Tables 6-1 and 6-2.

TABLE 6-1
Composition and Physical properties of Magenta toner 1 to 5

| | Composition of Toners | | | | | | | |
|---|---|---|---|---|---|---|---|---|
| | | | | | | | Wax | |
| | | | | | | | | Molecular |
| | Binding resin | | | | | Pigment | | number |
| | Styrene | BA | Crystalline Resin | | Pigment | Dispersant | Type | (Mn) |
| Magenta toner 1 | 46.0 | 19.0 | C-1 | 35.0 | PR-122 | Sy-1 | Dipentaerythritol | 1850 |
| | | | | | PR-150 | | hexastearate | |
| Magenta toner 2 | 46.0 | 19.0 | C-1 | 35.0 | PR-122 | Sy-2 | Dipentaerythritol | 1850 |
| | | | | | PR-150 | | hexastearate | |
| Magenta toner 3 | 46.0 | 19.0 | C-1 | 35.0 | PR-122 | Sy-3 | Dipentaerythritol | 1850 |
| | | | | | PR-150 | | hexastearate | |
| Magenta toner 4 | 46.0 | 19.0 | C-1 | 35.0 | PR-122 | Sy-4 | Dipentaerythritol | 1850 |
| | | | | | PR-150 | | hexastearate | |
| Magenta toner 5 | 46.0 | 19.0 | C-1 | 35.0 | PR-122 | Sy-5 | Dipentaerythritol | 1850 |
| | | | | | PR-150 | | hexastearate | |

TABLE 6-2
Composition and Physical properties of Magenta toner 1 to 5

| | Physical properties of Toners | | |
|---|---|---|---|
| | Particle | | |
| | diameter | Molecular | |
| | (D4) μm | weight (Mw) | \|P1-P2\| |
| Magenta toner 1 | 6.8 | 60000 | 0.02 |
| Magenta toner 2 | 7 | 61000 | 0.1 |
| Magenta toner 3 | 6.8 | 59000 | 0.09 |
| Magenta toner 4 | 6.7 | 60000 | 0.02 |
| Magenta toner 5 | 6.9 | 58000 | 0.02 |

### Production Example of Yellow Toner 1

### [Step of Preparing Colorant Dispersion Liquid 2]

| | | |
|---|---|---|
| Styrene monomer | 100.0 | parts |
| Pigment Yellow 155 (PY-155) (Paliotol Yellow D1155 | 20.0 | parts |
| [manufactured by BASF]) | | |
| Pigment dispersant (Sy-1) | 2.0 | parts |

The above-mentioned materials were introduced into an attritor (manufactured by Mitsui Mining Co., Ltd.) and were stirred with zirconia beads (200 parts) each having a radius of 2.5 mm at 200 rpm and 25° C. for 180 minutes to prepare a colorant dispersion liquid 2.

From then on, a yellow toner 1 was obtained in the same manner as in the black toner 1. The composition and physical properties of the resultant yellow toner 1 are shown in Tables 7-1 and 7-2.

### Production Examples of Yellow Toners 2 to 5

Yellow toners 2 to 5 were each obtained in the same manner as in the production example of the yellow toner 1 except that the pigment of the yellow toner 1 was changed as shown in Tables 7-1 and 7-2. The composition and physical properties of each of the yellow toners 2 to 5 are shown in Tables 7-1 and 7-2.

TABLE 7-1
Composition and Physical properties of Yellow toner 1 to 5

| | Composition of Toner | | | | | | | |
|---|---|---|---|---|---|---|---|---|
| | | | | | | | Wax | |
| | | | | | | | | Molecular |
| | Binding resin | | | | | Pigment | | weight |
| | Styrene | BA | Crystalline resin | | Pigment | dispersant | Type | (Mn) |
| Yellow toner 1 | 46.0 | 19.0 | C-1 | 35.0 | PY-155 | Sy-1 | Dipentaerythritol | 1850 |
| | | | | | | | hexastearate | |
| Yellow toner 2 | 46.0 | 19.0 | C-1 | 35.0 | PY-74 | Sy-1 | Dipentaerythritol | 1850 |
| | | | | | | | hexastearate | |
| Yellow toner 3 | 46.0 | 19.0 | C-1 | 35.0 | PY-93 | Sy-1 | Dipentaerythritol | 1850 |
| | | | | | | | hexastearate | |
| Yellow toner 4 | 46.0 | 19.0 | C-1 | 35.0 | PY-180 | Sy-1 | Dipentaerythritol | 1850 |
| | | | | | | | hexastearate | |
| Yellow toner 5 | 46.0 | 19.0 | C-1 | 35.0 | PY-185 | Sy-1 | Dipentaerythritol | 1850 |
| | | | | | | | hexastearate | |

TABLE 7-2
Composition and Physical properties of Yellow toner 1 to 5

| | Physical Properties of Toner | | |
|---|---|---|---|
| | Particle | Molecular | |
| | diameter | weight | |
| | (D4) μm | (Mw) | \|P1-P2\| |
| Yellow toner 1 | 6.7 | 58000 | 0.02 |
| Yellow toner 2 | 6.8 | 60000 | 0.02 |
| Yellow toner 3 | 6.9 | 59000 | 0.02 |
| Yellow toner 4 | 6.8 | 59000 | 0.02 |
| Yellow toner 5 | 7.0 | 58000 | 0.02 |

### Production Example of Cyan Toner 1

### [Step of Preparing Colorant Dispersion Liquid 2]

| | | |
|---|---|---|
| Styrene monomer | 100.0 | parts |
| Pigment Blue 15:3 (ECB-308 [manufactured by | 20.0 | parts |
| Dainichiseika Color & Chemicals Mfg. Co., Ltd.]) | | |
| Pigment dispersant (Sy-1) | 2.0 | parts |

The above-mentioned materials were introduced into an attritor (manufactured by Mitsui Mining Co., Ltd.) and were stirred with zirconia beads (200 parts) each having a radius of 2.5 mm at 200 rpm and 25° C. for 180 minutes to prepare a colorant dispersion liquid 2.

From then on, a cyan toner 1 was obtained in the same manner as in the black toner 1. The composition and physical properties of the resultant cyan toner 1 are shown in Tables 8-1 and 8-2.

### Production Examples of Cyan Toners 2 to 5

Cyan toners 2 to 5 were each obtained in the same manner as in the production example of the cyan toner 1 except that the pigment dispersant of the cyan toner 1 was changed as shown in Tables 8-1 and 8-2. The composition and physical properties of each of the cyan toners 2 to 5 are shown in Tables 8-1 and 8-2.

TABLE 8-1
Composition and Physical properties of Cyan toner 1 to 5

| | Composition of Toner | | | | | | | |
|---|---|---|---|---|---|---|---|---|
| | | | | | | | Wax | |
| | | | | | | | | Molecular |
| | Binding resin | | | | | Pigment | | weight |
| | Styrene | BA | Crystalline resin | | Pigment | dispersant | Type | (Mn) |
| Cyan toner 1 | 46.0 | 19.0 | C-1 | 35.0 | PB-15:3 | Sy-1 | Dipentaerythritol | 1850 |
| | | | | | | | hexastearate | |
| Cyan toner 2 | 46.0 | 19.0 | C-1 | 35.0 | PB-15:3 | Sy-2 | Dipentaerythritol | 1850 |
| | | | | | | | hexastearate | |
| Cyan toner 3 | 46.0 | 19.0 | C-1 | 35.0 | PB-15:3 | Sy-3 | Dipentaerythritol | 1850 |
| | | | | | | | hexastearate | |
| Cyan toner 4 | 46.0 | 19.0 | C-1 | 35.0 | PB-15:3 | Sy-4 | Dipentaerythritol | 1850 |
| | | | | | | | hexastearate | |
| Cyan toner 5 | 46.0 | 19.0 | C-1 | 35.0 | PB-15:3 | Sy-5 | Dipentaerythritol | 1850 |
| | | | | | | | hexastearate | |

TABLE 8-2
Composition and Physical properties of Cyan toner 1 to 5

| | Physical Properties of Toner | | |
|---|---|---|---|
| | Particle | Molecular | |
| | diameter | weight | |
| | (D4) μm | (Mw) | \|P1-P2\| |
| Cyan toner 1 | 6.7 | 55000 | 0.02 |
| Cyan toner 2 | 6.8 | 58000 | 0.10 |
| Cyan toner 3 | 6.5 | 56000 | 0.09 |
| Cyan toner 4 | 6.7 | 58000 | 0.02 |
| Cyan toner 5 | 6.8 | 56000 | 0.02 |

### <Image Evaluation>

An image evaluation was performed by partially reconstructing a commercially available color laser printer [HP LaserJet Enterprise Color M555dn]. The printer was reconstructed so as to operate even when mounted only with a process cartridge for one color. In addition, the printer was reconstructed so that the temperature of its fixing unit was able to be changed to an arbitrary value.

A toner stored in a process cartridge for a black toner mounted on the color laser printer was removed from the cartridge and the inside of the cartridge was cleaned by air blowing. After that, each toner (250 g) was introduced into the process cartridge and the process cartridge refilled with the toner was mounted on the color laser printer, followed by the following image evaluations. Specific image evaluation items are as described below.

### [Method of Evaluating Coloring Power]

A rectangular solid image (toner laid-on level: 0.45 mg/cm²) measuring 6.5 cm by 14.0 cm was output at the center of a transfer material and used as an evaluation image. The coloring power of the toner was evaluated by measuring an image density in the evaluation image. The image density was measured with “X-Rite Color Reflection Densitometer (X-Rite 404A).” Densities were measured at the following five points of the solid image portion and their average was evaluated as the image density: upper right, upper left, central, lower right and lower left portions. Letter-size gloss paper (HP Brochure Paper 150 g, Glossy) was used as the transfer material.

### (Evaluation Criteria)

A: The image density is 1.60 or more.
B: The image density is 1.50 or more to less than 1.60.
C: The image density is 1.40 or more to less than 1.50.
D: The image density is less than 1.40.

### [Method of Evaluating Low-Temperature Fixability]

A solid image (toner laid-on level: 0.45 mg/cm²) was printed on a transfer material while a fixation temperature was changed in increments of 5° C., followed by an evaluation by the following criteria. The fixation temperature is a value obtained by measuring the temperature of the surface of a fixing roller with a noncontact temperature gauge. Letter-size plain paper (Vitality, manufactured by Xerox Corporation, 75 g/m²) was used as the transfer material.

### (Evaluation Criteria)

A: The low-temperature fixation starting temperature is 115° C. or less.
B: The low-temperature fixation starting temperature is from 120° C. to 130° C.
C: The low-temperature fixation starting temperature is from 135° C. to 145° C.
D: The low-temperature fixation starting temperature is 150° C. or more.

### [Method of Evaluating Hot Offset Resistance]

A fixed image was produced in the same manner as in the above-mentioned evaluation method and the maximum fixation temperature of the toner was evaluated. The maximum fixation temperature is defined as the maximum temperature at which no offset occurs.

### (Evaluation Criteria)

A: The maximum fixation temperature is 205° C. or more.
B: The maximum fixation temperature is 195° C. or 200° C.
C: The maximum fixation temperature is 185° C. or 190° C.
D: The maximum fixation temperature is 180° C. or less.

### <Method of Evaluating Storage Stability (Heat Resistance)>

5 Grams of each toner was loaded into a 50-milliliter resin-made cup and left to stand at a temperature of 60° C. and a humidity of 10% RH for 3 days. The presence or absence of an aggregate was examined and was evaluated by the following criteria.

### (Evaluation Criteria)

A: No aggregate occurs.
B: A slight aggregate occurs but collapses when lightly pressed with a finger.
C: An aggregate occurs and does not collapse even when lightly pressed with a finger.
D: Completely aggregate.

### <Method of Evaluating Streak (Developability)>

The following test was performed: under a high-temperature and high-humidity environment (at a temperature of 32° C. and a humidity of 85% RH), a horizontal line image having a print percentage of 1% was printed out on 30,000 sheets. After the completion of the test, a halftone (toner laid-on level: 0.25 mg/cm²) image was printed out on letter-size plain paper (Vitality, manufactured by Xerox Corporation, 75 g/m²). The presence or absence of a vertical streak in a sheet delivery direction in the halftone image was observed and the developability of the toner was evaluated as described below.

### (Evaluation Criteria)

A: No vertical streak occurs.
B: From one e to three vertical streaks in the sheet delivery direction occur on the image of the halftone portion.
C: From four to six vertical streaks in the sheet delivery direction occur on the image of the halftone portion.
D: Seven or more vertical streaks in the sheet delivery direction occur on the image of the halftone portion or a vertical streak having a width of 0.5 mm or more occurs thereon.

### Examples 1 to 20

The above-mentioned evaluations were performed by using the black toners 1 to 21 as toners in Examples 1 to 21. The evaluation results are shown in Tables 9-1 and 9-2.

### Comparative Examples 1 to 7

The above-mentioned evaluations were performed by using the black toners 21 to 27 as toners in Comparative Examples 1 to 7, respectively. The evaluation results are shown in Tables 9-1 and 9-2. In Comparative Example 4, the evaluations of the low-temperature fixability, hot offset resistance and developability of the black toner 24 were not performed because the particles of the toner completely aggregated in the evaluation of its heat resistance.

TABLE 9-1
Evaluation results of Examples 1 to 21 and Comparative Examples 1 to 7

| | | Coloring | | Heat | Low | | Hot-offset | | Developability |
|---|---|---|---|---|---|---|---|---|---|
| | | power | | resistance | temperature | | resistance | | (streaks) |
| Example 1 | Black toner 1 | A | 1.65 | A | A | 115 | A | 210 | A |
| Example 2 | Black toner 2 | A | 1.63 | A | A | 105 | A | 205 | A |
| Example 3 | Black toner 3 | B | 1.55 | A | C | 135 | A | 210 | A |
| Example 4 | Black toner 4 | A | 1.62 | A | A | 115 | A | 210 | A |
| Example 5 | Black toner 5 | A | 1.63 | A | A | 115 | A | 210 | A |
| Example 6 | Black toner 6 | A | 1.65 | A | A | 115 | A | 210 | A |
| Example 7 | Black toner 7 | A | 1.63 | A | A | 115 | A | 210 | A |
| Example 8 | Black toner 8 | B | 1.56 | A | A | 115 | A | 210 | B |
| Example 9 | Black toner 9 | B | 1.52 | A | A | 115 | A | 210 | A |
| Example 10 | Black toner 10 | B | 158 | A | A | 115 | A | 210 | A |
| Example 11 | Black toner 11 | A | 1.64 | B | A | 115 | A | 210 | A |
| Example 12 | Black toner 12 | A | 1.63 | A | A | 115 | A | 210 | A |
| Example 13 | Black toner 13 | B | 1.51 | A | A | 115 | A | 210 | A |
| Example 14 | Black toner 14 | B | 1.58 | A | A | 115 | A | 210 | A |
| Example 15 | Black toner 15 | A | 1.63 | C | A | 115 | A | 210 | A |
| Example 16 | Black toner 16 | B | 1.56 | A | B | 125 | B | 200 | B |
| Example 17 | Black toner 17 | A | 1.64 | B | B | 120 | A | 210 | A |
| Example 18 | Black toner 18 | B | 1.54 | B | A | 115 | C | 190 | A |
| Example 19 | Black toner 19 | B | 1.55 | A | B | 125 | A | 210 | A |
| Example 20 | Black toner 20 | A | 1.64 | A | A | 115 | C | 185 | C |

TABLE 9-2
Evaluation results of Examples 1 to 21 and Comparative Examples 1 to 7

| | | Coloring | | Heat | Low | | Hot-offset | | Developability |
|---|---|---|---|---|---|---|---|---|---|
| | | power | | resistance | temperature | | resistance | | (streaks) |
| Comparative | Black toner 21 | D | 1.32 | A | A | 115 | A | 210 | A |
| Example 1 | | | | | | | | | |
| Comparative | Black toner 22 | D | 1.38 | A | A | 115 | A | 210 | A |
| Example 2 | | | | | | | | | |
| Comparative | Black toner 23 | D | 1.28 | A | A | 115 | A | 210 | A |
| Example 3 | | | | | | | | | |
| Comparative | Black toner 24 | C | 1.42 | D | — | No | — | No | — |
| Example 4 | | | | | | evaluation | | evaluation | |
| Comparative | Black toner 25 | D | 1.30 | C | A | 115 | B | 195 | C |
| Example 5 | | | | | | | | | |
| Comparative | Black toner 26 | D | 1.36 | A | A | 115 | A | 210 | A |
| Example 6 | | | | | | | | | |
| Comparative | Black toner 27 | D | 1.38 | A | D | 150 | A | 210 | A |
| Example 7 | | | | | | | | | |

### Examples 21 to 35

The above-mentioned evaluations were performed by using the magenta toners 1 to 5 as toners in Examples 21 to 25, respectively. The above-mentioned evaluations were performed by using the yellow toners 1 to 5 as toners in Examples 26 to 30, respectively. The above-mentioned evaluations were performed by using the cyan toners 1 to 5 as toners in Examples 31 to 35, respectively. The evaluation results are shown in Table 10.

TABLE 10
Evaluation results of Examples 21 to 35

| | | Coloring | | Heat | Low | | Hot-offset | | Developability |
|---|---|---|---|---|---|---|---|---|---|
| | | power | | resistance | temperature | | resistance | | (streaks) |
| Example 21 | Magenta toner 1 | A | 1.62 | A | A | 110 | A | 210 | A |
| Example 22 | Magenta toner 2 | A | 1.61 | A | A | 110 | A | 210 | A |
| Example 23 | Magenta toner 3 | A | 1.62 | A | A | 110 | A | 210 | A |
| Example 24 | Magenta toner 4 | A | 1.60 | A | A | 110 | A | 210 | A |
| Example 25 | Magenta toner 5 | A | 1.62 | A | A | 110 | A | 210 | A |
| Example 26 | Yellow toner 1 | A | 1.60 | A | A | 110 | A | 210 | A |
| Example 27 | Yellow toner 2 | A | 1.62 | A | A | 110 | A | 210 | A |
| Example 28 | Yellow toner 3 | A | 1.63 | A | A | 110 | A | 210 | A |
| Example 29 | Yellow toner 4 | A | 1.65 | A | A | 110 | A | 210 | A |
| Example 30 | Yellow toner 5 | A | 1.64 | A | A | 110 | A | 210 | A |
| Example 31 | Cyan toner 1 | A | 1.63 | A | A | 110 | A | 210 | A |
| Example 32 | Cyan toner 2 | A | 1.62 | A | A | 110 | A | 210 | A |
| Example 33 | Cyan toner 3 | A | 1.62 | A | A | 110 | A | 210 | A |
| Example 34 | Cyan toner 4 | A | 1.63 | A | A | 110 | A | 210 | A |
| Example 35 | Cyan toner 5 | A | 1.62 | A | A | 110 | A | 210 | A |

According to the present disclosure, the toner excellent in low-temperature fixability and coloring power can be provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-204138, filed Dec. 21, 2022, which is hereby incorporated by reference herein in its entirety.

What is claimed is:

1. A toner comprising a toner particle comprising a binder resin, a pigment and a pigment dispersant,
wherein the binder resin comprises from 20.0% to 100.0% by mass of a crystalline resin,
wherein the pigment dispersant comprises: a structure represented by the following formula (1); and a polymer moiety comprising a monomer unit represented by the following formula (3),
wherein a content of the structure represented by the following formula (1) in the pigment dispersant is from 1.0% to 15.0% by mass,
wherein a content of the monomer unit represented by the following formula (3) in the pigment dispersant is from 45.0% to 80.0% by mass, and
wherein the pigment dispersant has a weight-average molecular weight (Mw) from 10,000 to 50,000: 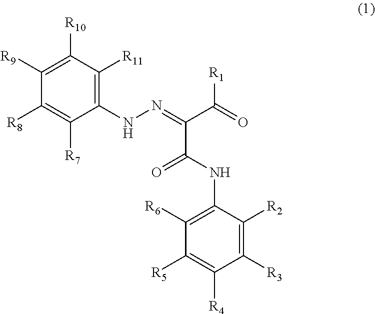
in the formula (1),
R₁ represents an alkyl group having a substituent, an alkyl group free of a substituent, a phenyl group having a substituent or a phenyl group free of a substituent,
at least one of R₂, R₃, R₄, R₅, R₆, R₇, R₈, R₉, R₁₀ or R₁₁ represents a linking group to the polymer moiety or a moiety that is bonded to the polymer moiety with a single bond, and
R₂ to R₁₁ except the linking group each independently represent a hydrogen atom, a halogen atom, an alkyl group, an alkoxy group, a hydroxy group, an amino group, a cyano group, a trifluoromethyl group, a carboxy group or a group represented by the following formula (2-1) or adjacent groups out of R₂ to R₁₁ form a group represented by the following formula (2-2); 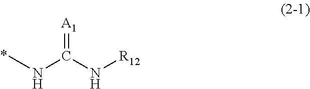
in the formula (2-1),
* represents a bonding site to an aromatic ring having R₂ to R₆ or R₇ to R₁₁ in the formula (1),
R₁₂ represents a hydrogen atom, a substituted or unsubstituted alkyl group, an aralkyl group, a substituted or unsubstituted alkyloxycarbonyl group or a substituted or unsubstituted aralkyloxycarbonyl group,
A₁ represents an oxygen atom, a sulfur atom or an NR₁₃ group, and
R₁₃ represents a hydrogen atom, a substituted or unsubstituted alkyloxycarbonyl group or a substituted or unsubstituted aralkyloxycarbonyl group; 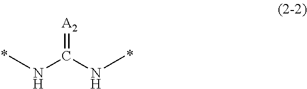
in the formula (2-2),
* represents a bonding site to an aromatic ring having R₂ to R₆ or R₇ to R₁₁ in the formula (1),
the group represented by the formula (2-2) forms a 5-membered heterocycle by being bonded to the aromatic ring having R₂ to R₆ or R₇ to R₁₁ in the formula (1),
A₂ represents an oxygen atom, a sulfur atom or an NR₁₃ group, and
R₁₃ represents a hydrogen atom, a substituted or unsubstituted alkyloxycarbonyl group or a substituted or unsubstituted aralkyloxycarbonyl group; and 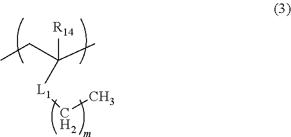
in the formula (3),
R₁₄ represents a hydrogen atom or a methyl group,
L₁ represents an ester bond or an amide bond, and
“m” represents an integer from 20 to 30.

2. The toner according to claim 1, wherein, in the structure represented by the formula (1), at least one of R₂, R₃, R₄, R₅, R₆, R₇, R₈, R₉, R₁₀ or R₁₁ represents the group represented by the formula (2-1) or the adjacent groups out of R₂ to R₁₁ form the group represented by the formula (2-2).

3. The toner according to claim 1, wherein the structure represented by the formula (1) is a structure represented by the following formula (4): 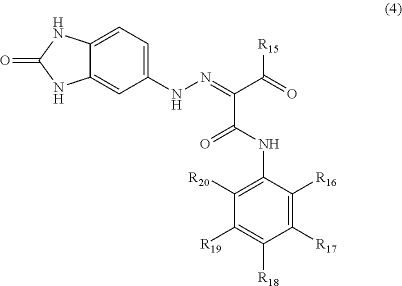
in the formula (4),
R₁₅ represents a substituted or unsubstituted alkyl group or a substituted or unsubstituted phenyl group,
at least one of R₁₆, R₁₇, R₁₈, R₁₉ or R₂₀ represents a linking group that forms a bonding portion to the polymer moiety, and
R₁₆ to R₂₀ except the linking group each independently represent a hydrogen atom, a halogen atom, an alkyl group, an alkoxy group, a hydroxy group, an amino group, a cyano group, a trifluoromethyl group or a carboxy group.

4. The toner according to claim 1, wherein the pigment dispersant has a melting point peak derived from a polymer moiety comprising the polymer moiety at from 50° C. to 70° C. in DSC measurement.

5. The toner according to claim 1,
wherein the binder resin comprises an amorphous resin, and
wherein when a section of the toner particle is observed with a scanning transmission electron microscope, a matrix-domain structure is observed in the section, the crystalline resin is incorporated as a main component into a matrix and the amorphous resin is incorporated as a main component into a domain.

6. The toner according to claim 1, wherein the crystalline resin comprises a structure represented by the following formula (5): 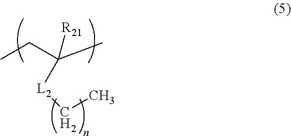
in the formula (5),
R₂₁ represents a hydrogen atom or a methyl group,
L₂ represents a single bond, an ester bond or an amide bond, and
“n” represents an integer from 15 to 30.

7. The toner according to claim 1, wherein a polarity parameter P1 of the pigment dispersant and a polarity parameter P2 of the crystalline resin satisfy the following formula:
$$\vert P 1 - P 2 \vert \leq 0.1$$
where P1 represents a volume fraction of acetonitrile at a precipitation point of the pigment dispersant determined by adding 0.10 part by mass of acetonitrile to a solution formed of 0.05 part by mass of the pigment dispersant and 1.48 parts by mass of chloroform, and
P2 represents a volume fraction of acetonitrile at a precipitation point of the crystalline resin when 0.10 part by mass of acetonitrile is added to a solution formed of 0.05 part by mass of the crystalline resin and 1.48 parts by mass of chloroform.

8. The toner according to claim 1, wherein the toner particle comprises a wax and the wax has a number-average molecular weight (Mn) from 300 to 3,000.

9. The toner according to claim 8, wherein the wax is an ester wax.

10. The toner according to claim 9, wherein the wax is one of an ester of an alcohol that is from tetrahydric to octahydric and an aliphatic monocarboxylic acid or an ester of a carboxylic acid that is from tetravalent to octavalent and an aliphatic monoalcohol.

11. The toner according to claim 1, wherein the pigment comprises a pigment selected from the following group: carbon black; C.I. Pigment Yellows 74, 93, 139, 155, 180 and 185; C.I. Pigment Reds 31, 122, 150, 170, 258 and 269; and C.I. Pigment Blues 15:3 and 15:4.
